(19) United States
(12) Patent Application Publication
(10) Pub. No.: US 2019/0066173 A1
(43) Pub. Date: Feb. 28, 2019

(54) SYSTEMS AND METHODS FOR BUYING GROUP PLATFORM

(71) Applicant: Exactus Advisors LLP, Chicago, IL (US)

(72) Inventors: Thomas G. Lebamoff, Naperville, IL (US); Bruce S. Rylance, Lake Forest, IL (US); Steven Y. Zingsheim, Henderson, NV (US)

(21) Appl. No.: 16/115,770

(22) Filed: Aug. 29, 2018

Related U.S. Application Data
(60) Provisional application No. 62/551,756, filed on Aug. 29, 2017.

(51) Int. Cl. G06Q 30/06; G06Q 30/02

(52) U.S. Cl. CPC G06Q 30/0605; G06Q 30/0223

(57) ABSTRACT

A platform for managing activities of a buying group receives information on a purchase, by a member, of a product sold by a non-associated vendor. A product database stores product information relating to a substitute product sold by an associated vendor. A vendor database stores vendor information indicating that the associated vendor provides benefit(s) for a purchase of the substitute product. A computing system: identifies, from the purchase data, the purchase of the product from the non-associated vendor; identifies, from the product database, the substitute product sold by the associated vendor by determining a correlation between the product sold by the non-associated vendor and the substitute product; determines, from the vendor database, the benefit(s) for the purchase of the substitute product; generates dashboard screen(s) providing information relating to the purchase of the product; and transmits the one or more dashboard screens for presentation to the member and/or the associated vendor.

### CROSS-REFERENCE TO RELATED APPLICATIONS

This application claims the benefit of, and priority to, U.S. Provisional Patent Application Ser. No. 62/551,756, filed Aug. 29, 2017, the contents of which are incorporated entirely herein by reference.

### BACKGROUND

### Field

The present disclosure relates generally to systems and methods for managing aspects of a buying group, and more particularly, to systems and methods for evaluating missed opportunities for sales/purchases between vendors and members of a buying group.

### Description of Related Art

Buyers can purchase products from one or more vendors. Each vendor may offer different purchasing terms for the products. As such, buyers typically attempt to find the most favorable purchasing terms for the products they purchase.

### SUMMARY

According to aspects of the present disclosure, systems and methods process purchase data from members of a buying group and sales data from vendors associated with the buying group to evaluate missed opportunities for purchases/sales between the members and the associated vendors. For instance, systems and methods can identify opportunities where the members missed out on receiving favorable purchasing terms offered by the associated vendors. Such favorable purchasing terms may include benefits, such as rebates, commissions, and/or other incentives that encourage purchases from the associated vendors.

According to some embodiments, a platform for managing activities of a buying group includes one or more data interfaces that receive purchase data from one of a plurality of members of a buying group. The purchase data includes information on a purchase, by the one member, of a product sold by a non-associated vendor. The non-associated vendor is not associated with the buying group. The platform includes a product database that is stored on one or more computer-readable media and that stores product information relating to a substitute product sold by an associated vendor. The associated vendor is associated with the buying group. The platform includes a vendor database that is stored on the one or more computer-readable media and that stores vendor information relating to the associated vendor. The vendor information indicates that the associated vendor provides one or more benefits (e.g., rebates, commissions, etc.) for a purchase of the substitute product by any member of the buying group. The platform includes a computing system including one or more processors executing programmed instructions stored on the one or more computer-readable media. The computing system identifies, from the purchase data, the purchase of the product from the non-associated vendor by the one member. The computing system identifies, from the product database, the substitute product sold by the associated vendor by determining a correlation between the product sold by the non-associated vendor and the substitute product. The computing system determines, from the vendor database, the one or more benefits for the purchase of the substitute product. The computing system generates one or more dashboard screens providing information relating to the purchase of the product from the non-associated vendor by the one member. The computing system transmits, over a network, the one or more dashboard screens for presentation to at least one of the one member or the associated vendor.

According to some embodiments, a method for managing activities of a buying group includes receiving, via one or more data interfaces, purchase data from one of a plurality of members of a buying group. The purchase data includes information on a purchase, by the one member, of a product sold by a non-associated vendor. The non-associated vendor not being associated with the buying group. The method includes storing, on one or more computer-readable media, a product database including product information relating to a substitute product sold by an associated vendor. The associated vendor is associated with the buying group. The method includes storing, on the one or more computer-readable media, a vendor database including vendor information relating to the associated vendor. The vendor information indicates that the associated vendor provides one or more benefits for a purchase of the substitute product by any member of the buying group. The method includes identifying, from the purchase data, with a computing system including one or more processors, the purchase of the product from the non-associated vendor by the one member. The method includes identifying, from the product database, with the computing system, the substitute product sold by the associated vendor by determining a correlation between the product sold by the non-associated vendor and the substitute product sold by the associated vendor. The method includes determining, from the vendor database, with the computing system, the one or more benefits for the purchase of the substitute product. The method includes generating one or more dashboard screens providing information relating to the purchase of the product from the non-associated vendor by the one member. The method includes transmitting, over a network, with the computing system, the one or more dashboard screens for presentation to at least one of the one member or the associated vendor.

### BRIEF DESCRIPTION OF THE DRAWINGS

FIG. 1 illustrates example activities of a buying group.

FIG. 2 illustrates aspects of an example computer-based platform for managing activities of a buying group, according to aspects of the present disclosure.

FIG. 3 illustrates aspects of an example product database for a computer-based platform for managing activities of a buying group, according to aspects of the present disclosure.

FIG. 4 illustrates aspects of an example technical architecture for a computer-based platform for managing activities of a buying group, according to aspects of the present disclosure.

FIG. 5A illustrates an example dashboard screen for a vendor associated with a buying group as provided by a computer-based platform for managing activities of the buying group, where the dashboard screen reports a sales and rebate summary, according to aspects of the present disclosure.

FIG. 5B illustrates an example dashboard screen for a vendor associated with a buying group as provided by a computer-based platform for managing activities of the buying group, where the dashboard screen reports sales and rebate data for each member who purchased products from the associated vendor, according to aspects of the present disclosure.

FIG. 5C illustrates an example dashboard screen for a vendor associated with a buying group as provided by a computer-based platform for managing activities of the buying group, where the dashboard screen tracks the progress of attaining growth rebates, according to aspects of the present disclosure.

FIG. 5D illustrates an example dashboard screen for a vendor associated with a buying group as provided by a computer-based platform for managing activities of the buying group, where the dashboard screen reports data on missed opportunities for sales for the associated vendor, according to aspects of the present disclosure.

FIG. 5E illustrates an example dashboard screen for a vendor associated with a buying group as provided by a computer-based platform for managing activities of the buying group, where the dashboard screen reports further data on missed opportunities for sales for the associated vendor, according to aspects of the present disclosure.

FIG. 6A illustrates an example dashboard screen for a member of a buying group as provided by a computer-based platform for managing activities of the buying group, where the dashboard screen reports a purchase and rebate data summary, according to aspects of the present disclosure.

FIG. 6B illustrates an example dashboard screen for a member of a buying group as provided by a computer-based platform for managing activities of the buying group, where the dashboard screen reports purchase and rebate data for each vendor from whom the member purchased products, according to aspects of the present disclosure.

FIG. 6C illustrates an example dashboard screen for a member of a buying group as provided by a computer-based platform for managing activities of the buying group, where the dashboard screen reports invoice data, according to aspects of the present disclosure.

FIG. 6D illustrates an example dashboard screen for a member of a buying group as provided by a computer-based platform for managing activities of the buying group, where the dashboard screen reports purchases by the member from non-associated vendors and missed opportunities for rebates for such purchases, according to aspects of the present disclosure.

FIG. 6E illustrates an example dashboard screen for a member of a buying group as provided by a computer-based platform for managing activities of the buying group, where the dashboard screen provides information on products purchased from non-associated vendors by the member, according to aspects of the present disclosure.

FIG. 7A illustrates an example dashboard screen for an administrator of a buying group as provided by a computer-based platform for managing activities of the buying group, where the dashboard screen provides a sales and rebate overview for the buying group, according to aspects of the present disclosure.

FIG. 7B illustrates an example dashboard screen for an administrator of a buying group as provided by a computer-based platform for managing activities of the buying group, where the dashboard screen provides a sales and rebate overview for associated vendors of the buying group, according to aspects of the present disclosure.

FIG. 7C illustrates an example dashboard screen for an administrator of a buying group as provided by a computer-based platform for managing activities of the buying group, where the dashboard screen provides a sales and rebate overview for members of the buying group, according to aspects of the present disclosure.

FIG. 7D illustrates an example dashboard screen for an administrator of a buying group as provided by a computer-based platform for managing activities of the buying group, where the dashboard screen provides a sales overview for associated vendors of the buying group, according to aspects of the present disclosure.

FIG. 7E illustrates an example dashboard screen for an administrator of a buying group as provided by a computer-based platform for managing activities of the buying group, where the dashboard screen provides a purchase overview for members of the buying group, according to aspects of the present disclosure.

FIG. 7F illustrates an example dashboard screen for an administrator of a buying group as provided by a computer-based platform for managing activities of the buying group, where the dashboard screen provides an overview of progress of attaining growth rebates for selected product categories, according to aspects of the present disclosure.

FIG. 7G illustrates an example dashboard screen for an administrator of a buying group as provided by a computer-based platform for managing activities of the buying group, where the dashboard screen provides an overview of missed opportunities for members and associated vendors of the buying group, according to aspects of the present disclosure.

FIG. 7H illustrates an example dashboard screen for an administrator of a buying group as provided by a computer-based platform for managing activities of the buying group, where the dashboard screen provides an additional overview of missed opportunities for members and associated vendors of the buying group, according to aspects of the present disclosure.

FIG. 7I illustrates an example dashboard screen for an administrator of a buying group as provided by a computer-based platform for managing activities of the buying group, where the dashboard screen provides an additional overview of missed opportunities for members and associated vendors of the buying group based on a selected product group, according to aspects of the present disclosure.

FIG. 7J illustrates an example dashboard screen for an administrator of a buying group as provided by a computer-based platform for managing activities of the buying group, where the dashboard screen reports on compliance by associated vendors and members of the buying group, according to aspects of the present disclosure.

FIG. 7K illustrates an example dashboard screen for an administrator of a buying group as provided by a computer-based platform for managing activities of the buying group, where the dashboard screen reports on compliance by associated vendors of the buying group, according to aspects of the present disclosure.

FIG. 7L illustrates an example dashboard screen for an administrator of a buying group as provided by a computer-based platform for managing activities of the buying group, where the dashboard screen reports on compliance by members of the buying group, according to aspects of the present disclosure.

FIG. 7M illustrates an example pop-up window screen providing file upload information for the dashboard screens of FIG. 7K or 7L, according to aspects of the present disclosure.

### DESCRIPTION

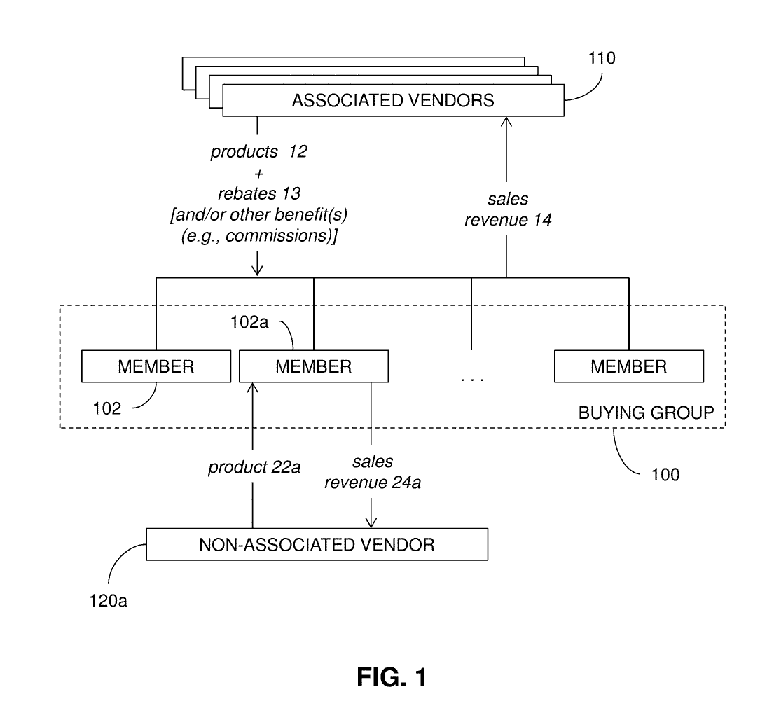

FIG. 1 illustrates example activities of a buying group 100. The buying group 100 includes a plurality of members 102. In some cases, the buying group 100 may be associated with a specific industry in which the members 102 conduct business (e.g., housing or building construction). The members 102 purchase products 12 from one or more associated vendors 110 who receive corresponding sales revenue 14 in return. The one or more associated vendors 110 agree to participate in sales transactions via the buying group 100. The products 12 may include any variety of goods and/or services, but in some cases, may be especially relevant to a specific industry in which the members 102 conduct business. By joining the buying group 100, the members 102 can leverage their purchasing power as a group to gain favorable purchasing terms from the associated vendors 110. In other words, the associated vendors 110 agree to provide the members 102 with favorable purchasing terms as incentives in exchange for the volume of potential sales from the group of members 102. In particular, the members 102 may receive rebates 13 (and/or other benefits) from the associated vendors 110 for the purchase of the products 12 through the buying group 100. In some cases, the buying group 100 may include a plurality of membership levels, where the favorable purchasing terms, including the rebates 13 (and/or other benefits), and other benefits available to each member 102 depend on the membership level to which the member 102 belongs. Although the examples described herein may involve the use of rebates, other embodiments may additionally or alternatively involve the use of other benefits, such as commissions, which provide incentives to encourage purchases from particular vendors. In some cases, commissions are offered to members whose activities (e.g., sales activities) result in purchases from the particular vendors.

As also illustrated in FIG. 1, a member 102a of the buying group 100 might purchase a product 22a from a non-associated vendor 120a who has not agreed to participate in sales transactions via the buying group 100 and to provide favorable purchasing terms to the buying group 100. In some cases, the product 22a is the same as, or similar to, one or more of the products 12 available from one or more of the associated vendors 110. In other words, the member 102a could have purchased the same product or an acceptable substitute from one of the associated vendors 110. By making the purchase from the non-associated vendor 120a, the member 102a does not receive the favorable purchasing terms available from one of the associated vendors 110. In particular, the member 102a cannot receive a rebate from one of the associated vendors 110. Meanwhile, none of the associated vendors 110 receives the sales revenue 24a associated with the purchase of the product 22a. Thus, the purchase of the product 22a results in a missed opportunity for the member 102a in terms of a lost rebate and for the associated vendors 110 in terms of the lost sales revenue 24a. Advantageously, aspects of the present disclosure allow systems and methods to identify such missed opportunities for the members 102 and the associated vendors 110.

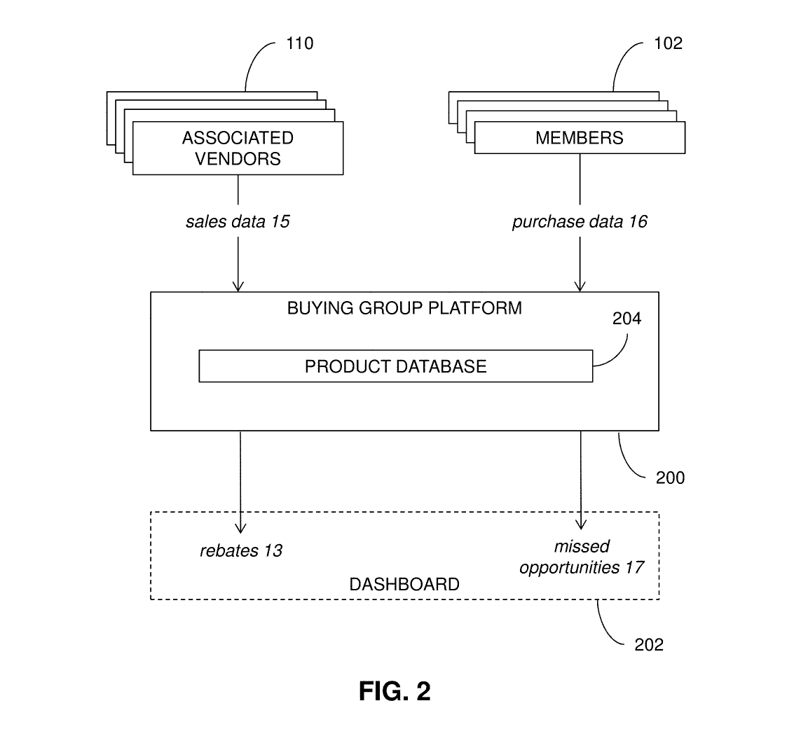

FIG. 2 illustrates aspects of an example computer-based platform 200 for managing activities of the buying group 100. In particular, the platform 200 receives sales data 15 from the associated vendors 110 and purchase data 16 from the members 102 of the buying group 100. The sales data 15 includes sales of all products by the associated vendors 110 to the members 102 over a given period of time (e.g., week, month, etc.). Meanwhile, the purchase data 16 includes purchases of all products by the members 102 from both associated vendors 110 and non-associated vendors 120 over a given period of time. The platform 200 processes the sales data 15 and the purchase data 16 to provide information that the members 102 and the associated vendors 110 can employ to evaluate their business activities in relation to the buying group 100.

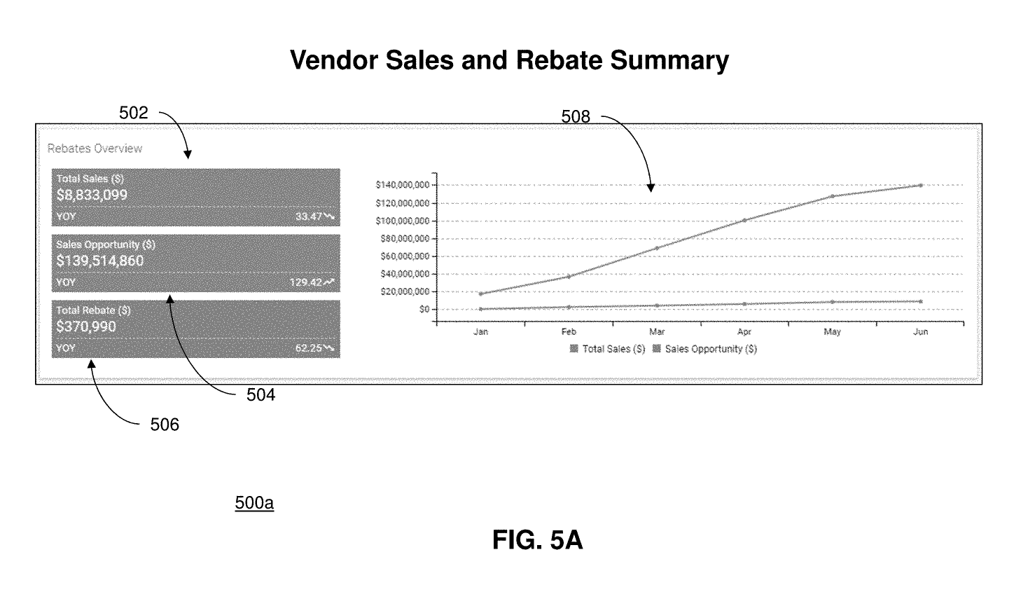

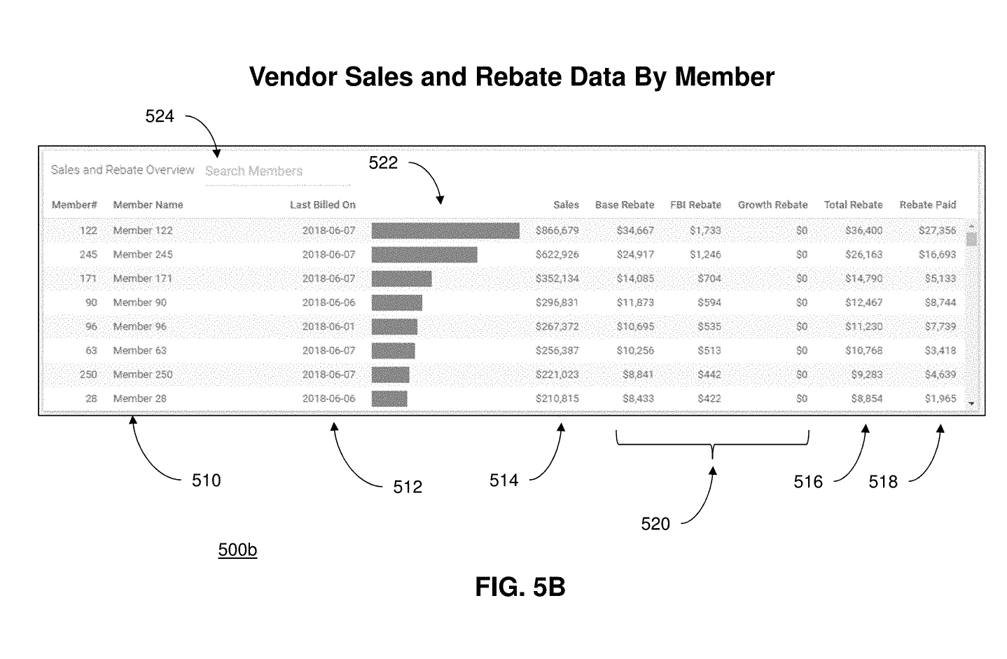

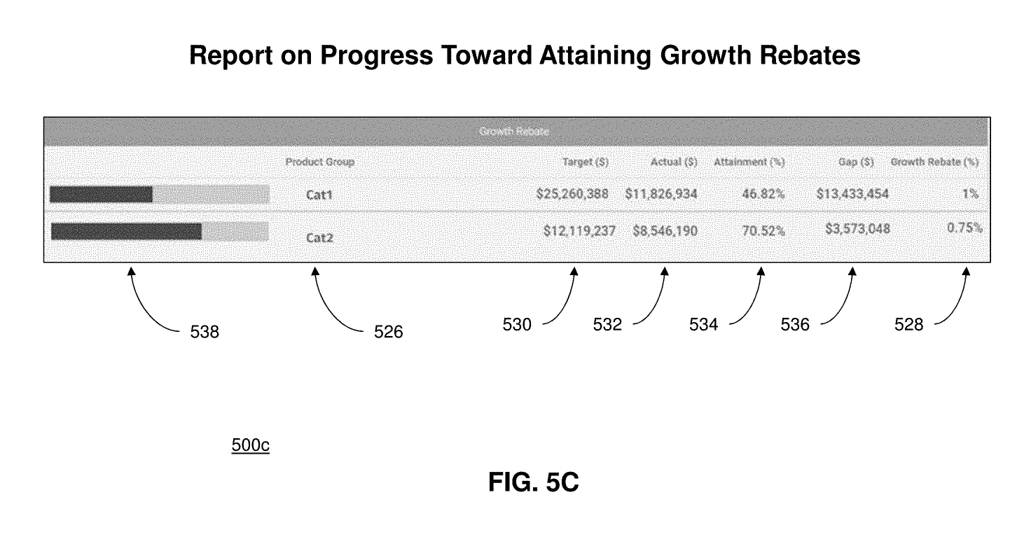

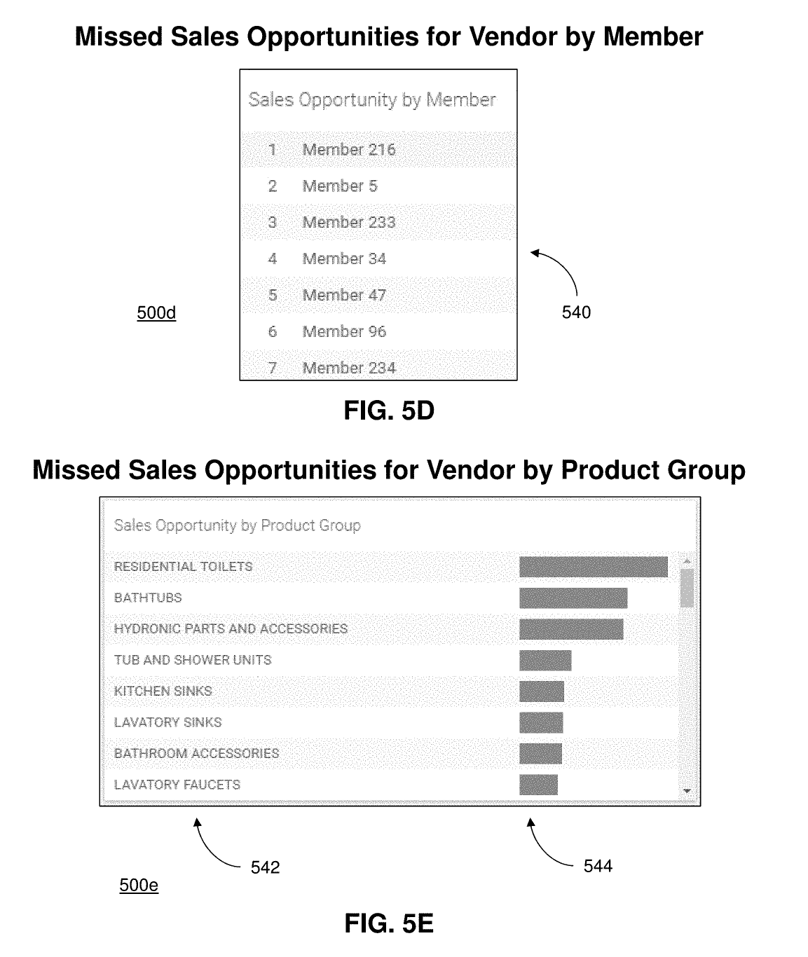

The platform 200 generates information dashboards 202 that report information that is derived from the processing of the sales data 15 and the purchase data 16. The dashboards 202 can be customized for each member 102 and each associated vendor 110. In particular, the platform 200 can process (e.g., reconcile) the sales data 15 and the purchase data 16 to identify the rebates 13 that were earned by the members 102 from associated vendors 110 over a given period of time. The platform 200 can then generate various dashboards 202 that present information relating to the rebates 13. The dashboards 202 may organize and present the information textually, graphically, and/or acoustically. Example information dashboards for the platform 200 are described further below with reference to FIGS. 5A-E, 6A-E, 7A-M.

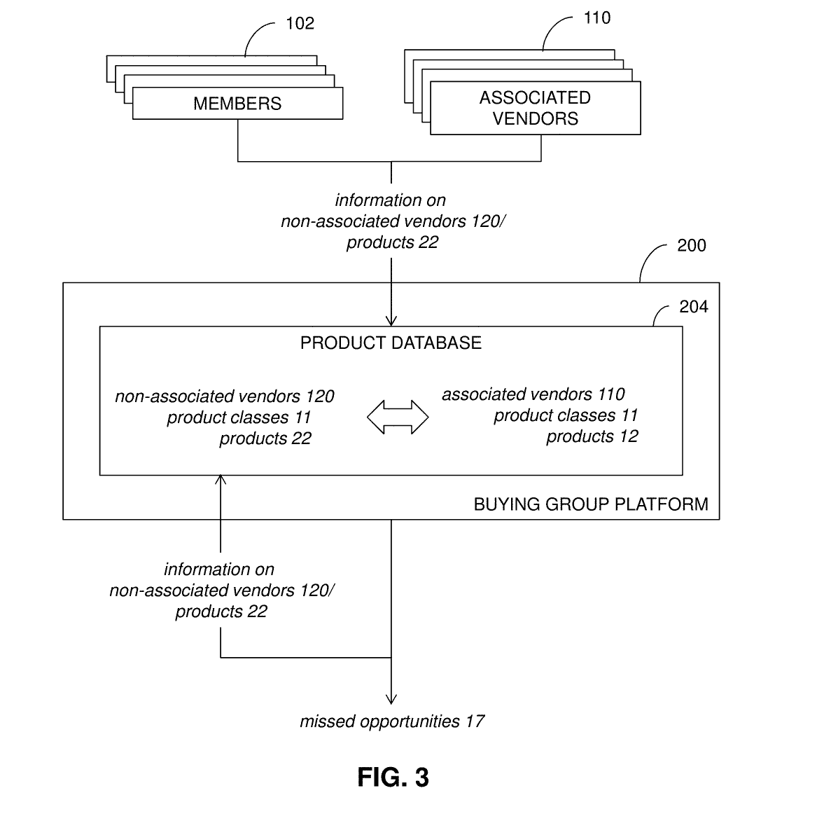

Advantageously, the platform 200 can process the sales data 15 and the purchase data 16 to identify missed opportunities 17 for the members 102 and the associated vendors 110. As shown in FIGS. 2 and 3, the platform 200 includes a product database 204, which is employed to identify the missed opportunities 17. Although the product database 204 may be implemented as a single database, it is understood that the product database 204 as referenced herein may represent any number of databases and/or sources of information that can be accessed in any manner to assist in the identification of the missed opportunities 17.

In particular, the product database 204 can store data on products 22 sold by non-associated vendors 120 as well as the products 12 sold by associated vendors 110. The product database 204 correlates the products 22 to the products 12 sold by the associated vendors 110. In other words, the product database 204 indicates which products 12 sold by the associated vendors 110 are the same as, or substitutes for, the products 22 sold by the non-associated vendors 120. In some cases, certain associated vendors 110 may be specifically identified as favorable (e.g., most suitable) vendors of products 12 that are the same as, or substitutes for, the products 22.

To indicate whether one or more products 12 are sufficiently similar to be acceptable substitutes for a product 22, the product database 204 may organize the products 12, 22 according to predefined, standard product groups 11. All products 12, 22 in a particular product group 11 share one or more characteristics that allow them to be considered to be substitutes, even if they are not the same products. A product 12, 22 may belong to more than one product group 11 if it shares characteristics with more than one set of products. In some cases, the products 12, 22 can be organized according to a series of product groups 11, where the product groups 11 represent varying levels of similarity. For instance, a product 22 may be a screw formed from a particular material with a particular screw head, length, diameter, thread, etc. At one level, the screw belong to a product group 11 for screws formed from any material with a particular screw head, length, diameter, and thread, etc. At another level, the screw may belong to a product group 11 for screws in general. At yet another level, the screw may belong to a product group 11 for fasteners more generally.

The information in the product database 204 is organized and stored according to a standard rules and formats (e.g., predefined data/table structures) to facilitate correlation of the products 12, 22. Moreover, the information on the products 12, 22 can be organized under designated product groups 11.

Referring to the example scenario above, by evaluating the purchase data 16 from the member 102a shown in FIG. 1, the platform 200 can identify the purchase of the product 22a by the member 102a from the non-associated vendor 120a. Using the product database 204, the platform 200 can determine whether the product 22a matches one of the products 12 sold by one or more associated vendors 110. In other words, the platform 200 can evaluate the product 22a as a stock keeping unit (SKU) and determine whether the product 22a is the same as one of the products 12. Additionally, the platform 200 can determine whether the product 22a falls into one or more product groups 11. As described above, the product groups 11 indicate whether one or more of the products 12 are sufficiently similar to be used as acceptable substitutes for the product 22a. In some cases, certain associated vendors 110 may be specifically identified as favorable vendors of one or more product groups 11 associated with the product 22a sold by the non-associated vendor 120a.

The platform 200 can identify missed opportunities 17 by determining whether the product 22a is the same as, or similar to, one or more products 12 sold by the associated vendors 110. Correspondingly, the dashboard 202 for the member 102a may indicate that the member 102a missed an opportunity to obtain a rebate associated with its purchase of the product 22a. In some cases, the dashboard 202 may also identify a favorable associated vendor 110 for the purchase of a product 12 that is the same as, or a substitute for, the product 22a. Meanwhile, if an associated vendor 110 sells a product 12 that is the same as, or shares a product group 11 with, the product 22a, the dashboard 202 for that associated vendor 110 may indicate a missed opportunity for a sale to the member 12a.

In general, the dashboards 202 report information on the missed opportunities 17 to allow members 102 to re-evaluate purchasing decisions that fail to take advantage of favorable purchasing terms, e.g., the rebates 13, available to the buying group 100. Correspondingly, with information on the missed opportunities 17, the associated vendors 110 can re-evaluate their product offerings and marketing to the buying group 100.

As shown in FIG. 3, the product database 204 may be created and periodically updated with information collected from the members 102, the associated vendors 110, and/or other sources. In some cases, the associated vendors 110 may identify, for inclusion in the product database 204, known competing products 22 and non-associated vendors 120, i.e., competitors, who sell the competing products 22. Such information may also be collected from other sources, such as other parties with knowledge of vendors and products in the relevant industry.

In other cases, the members 102 may provide information about products 22 that they purchase from non-associated vendors 120, allowing the products 22 to be correlated to products 12 sold by associated vendors 110. For instance, members 102 may indicate characteristics or properties of the products 22, allowing the products 22 to be associated with products 12 in one or more product groups 11.

When presented with information on the dashboards 202, the members 102 and the associated vendors 110 can also be prompted for feedback on the accuracy of the information regarding products 22 and/or non-associated vendors 120. The feedback can be evaluated to determine whether information in the product database 204 should be dynamically updated.

As described previously, the platform 200 employs the product database 204 to identify the missed opportunities 17. Information from the process of evaluating missed opportunities 17 can also be used to update information on the products 22 and the non-associated vendors 120 identified in the product database 204. For instance, in the example scenario above, the platform 200 evaluates the purchase data 16 from the member 102a to identify the purchase of the product 22a from the non-associated vendor 120a. In some cases, the product 22a might not be among the existing products identified in the product database 204. Additionally, the non-associated vendor 120a might not be among the competing vendors identified in the product database 204. The platform 200 can flag the product 22a and/or the non-associated vendor 120a for further evaluation.

In some cases, the platform 200 can parse the information on the product 22a to correlate initially the product 22a and one or more products 12 from the associated vendors 110. For instance, the platform 200 may identify key word(s) in the name/description of the product 22a that match key word(s) in the names/descriptions of one or more products 12 from the associated vendors 110. Alternatively or additionally, the platform 200 may identify key word(s) in the name/description of the product 22a that indicate that the product 22a belongs to one or more product groups 11, which also include one or more products 12 from the associated vendors 110.

If it is determined that the product 22a is similar to one or more products 12 from the associated vendors 110, the product database 204 can be dynamically updated to include information on the product 22a. If it is determined that the non-associated vendor 120a sells products that are similar to one or more products 12 from the associated vendors 110, the product database 204 can be dynamically updated to include information on the non-associated vendor 120a and its products. Thus, in future evaluation of purchase data 16, the platform 200 can more easily identify missed opportunities 17 relating to the product 22a and/or the non-associated vendor 120a. If a number of identified missed opportunities 17 are associated with the non-associated vendor 120a, the buying group 100 can even invite the non-associated vendor 120a to become an associated vendor 110 and provide favorable purchasing terms to the buying group 100.

Advantageously, dynamic updates as described above allow a larger and more accurate product database 204 to be developed over time. This development in turn allows the platform 200 to identify the missed opportunities 17 more efficiently and more accurately. If the buying group 100 is associated with a specific industry, the product database 204 can develop into a comprehensive product and vendor listing for the specific industry. Furthermore, because the information in the product database 204 is organized and stored according to standard rules and formats, the product database 204 provides a more robust and clean source of data despite its growing size and the various sources of information. Such industry product databases have not been heretofore developed according to other approaches.

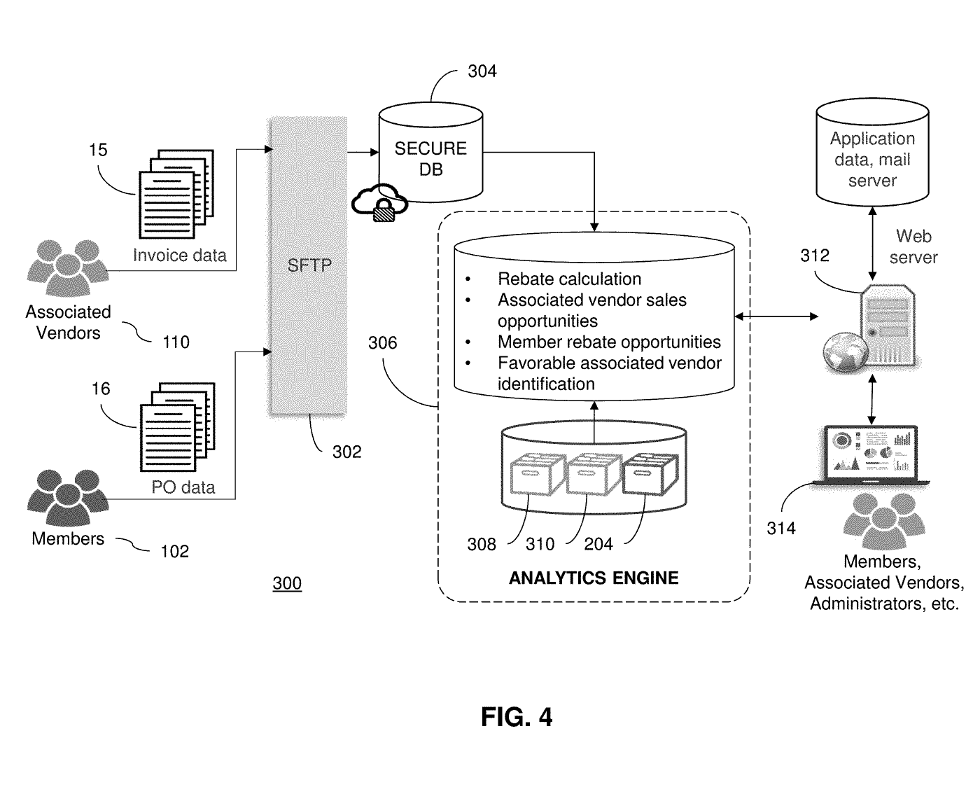

FIG. 4 illustrates an example technical architecture 300 for the buying group platform 200. Aspects of the technical architecture 300, for instance, can be developed and implemented as a cloud-based system. The technical architecture 300 interfaces with the members 102 of the buying group 100 and associated vendors 110. For instance, the technical architecture 300 employs a secure file transfer protocol (SFTP) system 302 to allow the members 102 and the associated vendors 110 to upload data electronically for processing by the platform 200. The technical architecture 300 does not permit members 102 to see data from other members 102. Similarly, the technical architecture 300 does not permit associated vendors 110 to see data from other associated vendors 110. As such, each member 102 and vendor 110 receives a unique respective identification for accessing the SFTP system 302. Additionally or alternatively, the technical architecture 300 may provide other data interfaces, such as email, etc., for electronically communicating data to the platform 200. As shown in FIG. 4, the associated vendors 110 may upload sales data 15 in the form of weekly or monthly invoice data. Meanwhile, the members 102 may upload purchase data 16 in the form of weekly or monthly purchase order data.

The technical architecture 300 includes a secure database 304 (e.g., on a secure cloud) for receiving and storing the sales data 15 and the purchase data 16 uploaded by the associated vendors 110 and the members 102, respectively. It is understood that the technical architecture 300 may employ various approaches (e.g., file systems) to manage the secure and robust exchange and storage of data.

The technical architecture 300 also includes an analytics engine 306 that processes the sales data 15 and purchase data 16 along with data from the product database 204 described above as well as a member database 308 and a vendor database 310. The member database 308 may store information on each member 102. For instance, the member database 308 may store information relating to the membership level of each member 102. Meanwhile, the vendor database 310 may store information on each associated vendor 110, including the rebates 13 offered by each vendor 110. The analytic engine 306 may include a data consolidator/aggregator, which brings the sales data 15 and the purchase data 16 together with data from the member database 308 and the vendor database 310.

Among various operations, the analytics engine 306 can determine the rebates 13 that are payable from the associated vendors 110 to the members 102 for qualifying purchases of the products 12. The analytics engine 306 can also identify missed opportunities 17 for sales by the associated vendors 110 based on purchases of products 22 by the members 102 from non-associated vendors 120. Correspondingly, the analytics engine 306 can identify missed opportunities 17 for rebates 13 for the members 102 based on purchases of products 22 by the members 102 from non-associated vendors 120. Additionally, the analytics engine 306 can also process information relating to the product database 204. For instance, the analytics engine 306 can update information relating to the favorable associated vendors 110 associated with product groups 11 and/or products 12.

The analytics engine 306 can apply rules to calculate the rebates 13 earned by the members 102 and owed by each associated vendor 110 over a given period of time. To calculate the rebates 13, the analytics engine 306 reconciles the sales data 15 from the associated vendors 110 and the purchase data 16 from the members 102. As described previously, the favorable purchasing terms, including the rebates 13, available to each member 102 may depend on the membership level to which the member 102 belongs. As such, the rules applied by the analytics engine 306 to calculate the rebates 13 may depend on the membership levels of each member 102 as stored in the member database 308.

In addition, the analytics engine 306 evaluates the purchase data 16 against the product database 204 to identify the missed opportunities 17. In particular, the analytics engine 306 determines purchases of products 22 from non-associated vendors 120 that could have been purchases of products 12 from associated vendors 110. The analytics engine 306 then calculates the rebates 13 that were missed by the members 102 and the sales revenue 14 that was lost by the associated vendors 110 from these purchases of products 22.

As described previously, embodiments may additionally or alternatively involve the use of other benefits, such as commissions, which provide incentives to encourage purchases from particular vendors. In such embodiments, an analytics engine can apply corresponding rules to calculate the other benefits earned by the members and owed by the associated vendors. The analytics engine can also calculate the benefits that were missed by the members and the sales revenue that was lost by the associated vendors from purchases of products from non-associated vendors rather than the associated vendors.

Once the information relating to the rebates 13 and the missed opportunities 17 has been determined, the dashboards 202 can be generated. The technical architecture 300 includes a web server system 312 that allows the dashboards 202 to be transmitted over the Internet or other network and presented to members 102, associated vendors 110, administrators of the buying group 100, and other users. Each member 102 and associated vendor 110 can retrieve its customized dashboards 202 via any computer device 314 with appropriate network access and the customized dashboards 202 can be presented via the user interface of the computer device 314. In addition to the members 102 and the associated vendors 110, other users, such as buying group administrators, may access dashboards 202 that present information for the entire buying group 100. As described below, the customized dashboards 202 also provide a communication interface for receiving feedback and other data from the users.

FIGS. 5A-E illustrate example dashboard screens 500a-d customized for a particular associated vendor 110 of the buying group 100. For a given time period (e.g., year-to-date), the dashboard screen 500a as shown in FIG. 5A reports a sales and rebate summary. The dashboard screen 500a presents: (i) a total amount 502 of sales revenue 14 received by the particular vendor from the members 102 of the buying group 100 and a corresponding indication of year-over-year (YOY) percentage increase/decrease; (ii) a total amount 504 of rebates 13 owed to the members 102 by the particular vendor 110 and a corresponding indication of YOY percentage increase/decrease; and (iii) a total amount 506 of sales revenue in missed opportunities 17 for the particular vendor 110 and a corresponding indication of YOY percentage increase/decrease. As described above, the total amount 506 of sales revenue from missed opportunities 17 indicates the total sales between the members 102 of the buying group 100 and non-associated vendors 120 for products 22 that are the same as, or substitutes for, the products 12 sold by the particular associated vendor 110. In other words, the particular vendor 110 could have otherwise received additional sales revenue 14 if the members 102 had purchased the products 12 from the particular vendor 110, instead of the products 22 from non-associated vendors 120. The dashboard screen 500a also provides a line graph 508 that compares the total amount 502 of sales revenue 14 and the total amount 506 of sales revenue in missed opportunities 17 over time (e.g., monthly) for the given time period.

The dashboard screen 500b as shown in FIG. 5B reports sales and rebate data for each member 102 who purchased products 12 from the particular vendor 110 for a given time period. The dashboard screen 500b presents: (i) a column 510 listing the members 102 who purchased products 12 from the particular vendor 110; (ii) a column 512 listing respective last-billing dates for each member 102 listed in the column 510, where the last-billing dates indicate data availability for the member 102; (iii) a column 514 listing respective sales revenue 14 from each member 102 listed in the column 510; (iv) a column 516 listing respective rebates 13 owed to each member 102 listed in the column 510; and (v) a column 518 listing respective rebates 13 actually paid to each member 102 listed in the column 510. The rebates 13 listed in column 516 may be broken down into different types of rebates (e.g., growth rebates), which is presented in additional columns 520. The dashboard screen 500b also provides a bar graph 522 that graphically indicates the respective sales revenue 14 from each member 102 listed in the column 510. Additionally, the dashboard screen 500b provides a function 524 (input field) that allows one to search for a member 102 listed in the column 510.

The dashboard screen 500c as shown in FIG. 5C reports on, i.e., tracks, the progress of attaining growth rebates for specific product categories for the particular vendor 110. Growth rebates, in this case, are designed to drive sales in a particular product category and can be attained when sales in the particular category reach target sales revenue. Thus, the dashboard screen 500c presents: (i) a column 526 listing product categories for which growth rebates are available; (ii) a column 528 listing respective growth rebates for each product category listed in the column 526; (iii) a column 530 listing respective target sales revenue that must be satisfied to attain each growth rebate listed in the column 528; (iv) a column 532 listing respective sales revenue 14 from the members 102 for each product category listed in the column 526, where the respective sales revenue 14 must meet the respective target sales revenue listed in the column 530 to attain the respective growth rebate listed in the column 528; (v) a column 534 listing the respective sales revenue listed in the column 532 as a percentage of the respective target sales revenue listed in the column 530, indicating the progress toward attaining the respective growth rebate listed in the column 528; and (vi) a column 536 listing respective differences between the respective sales revenue listed in the column 532 and the respective target sales revenue listed in the column 530, indicating the progress toward attaining the respective growth rebate listed in the column 528. The example dashboard screen 500c also provides a bar graph 538 that graphically indicates the progress toward attaining the respective growth rebates listed in the column 528. Other dashboard screens similar to the dashboard screen 500c may be employed to provide information on other types of rebates.

The dashboard screen 500d as shown in FIG. 5D reports data on missed opportunities 17 for sales for the particular vendor 110 for a given time period. The dashboard screen 500d presents a list 540 of members 102 who purchased, from non-associated vendors 120, products 22 that are the same as, or substitutes for, the products 12 sold by the particular vendor 110. The order of the members 102 in the list 540 may be determined according to the respective amount of missed opportunities 17 for sales from each member 102.

The dashboard screen 500e as shown in FIG. 5E reports on further data on missed opportunities 17 for sales for the particular vendor 110 for a given time period. The dashboard screen 500e presents a column 542 listing product groups under which the members 102 purchased, from non-associated vendors 120, products 22 that are the same as, or substitutes for, the products 12 sold by the particular vendor 110. The dashboard screen 500e also presents a bar graph 544 that graphically indicates the amount of missed opportunity 17 for sales under each product group listed in the column 542.

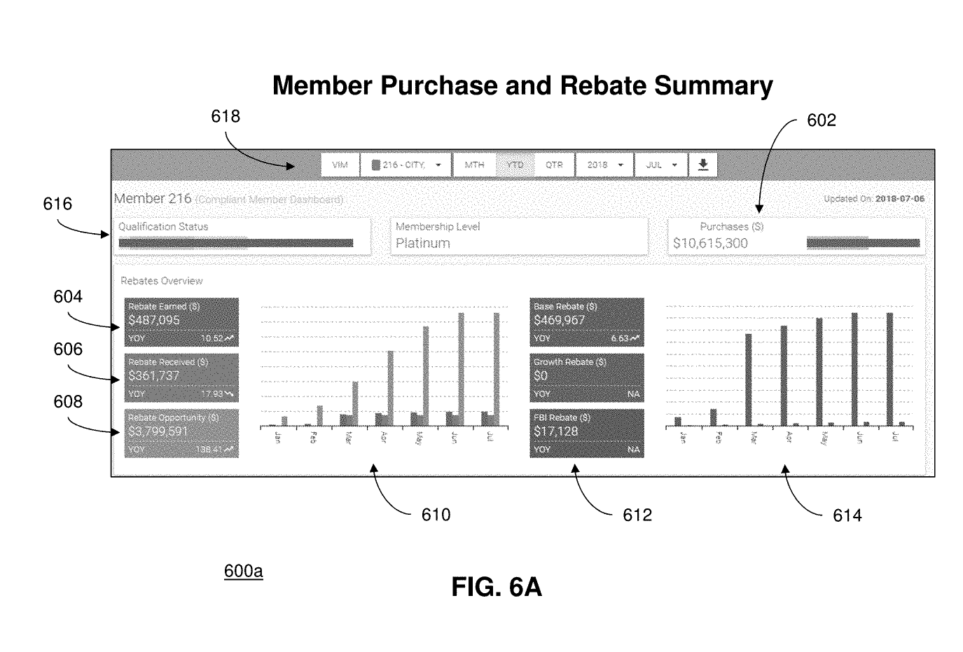

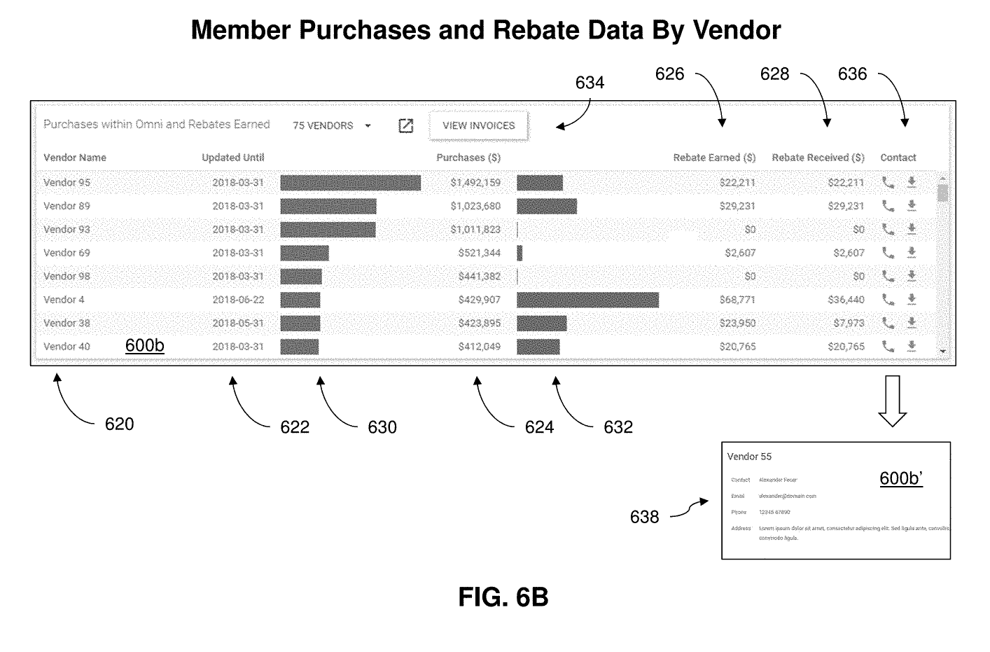

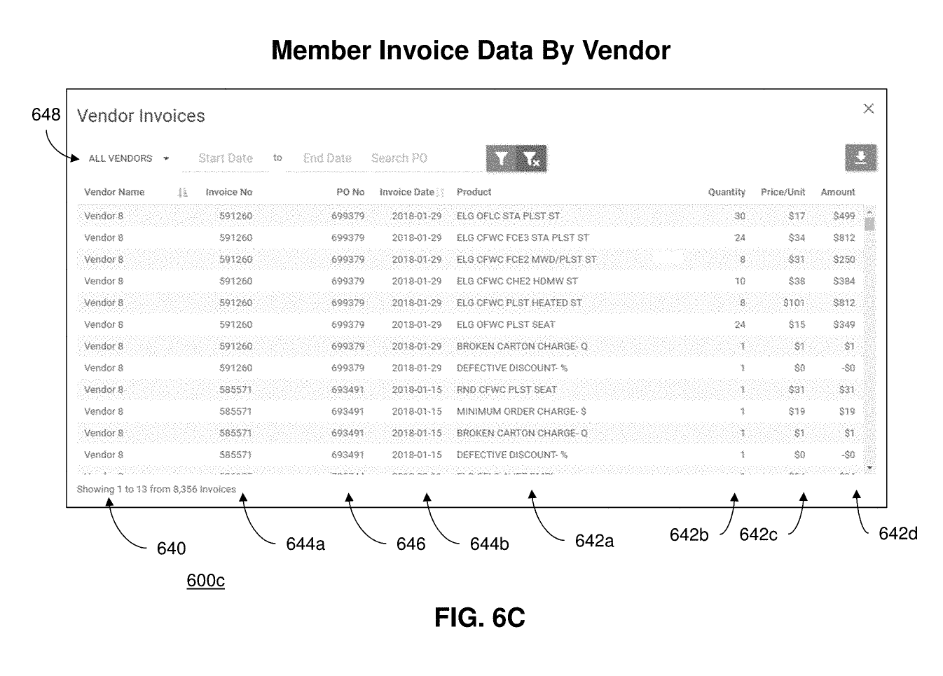

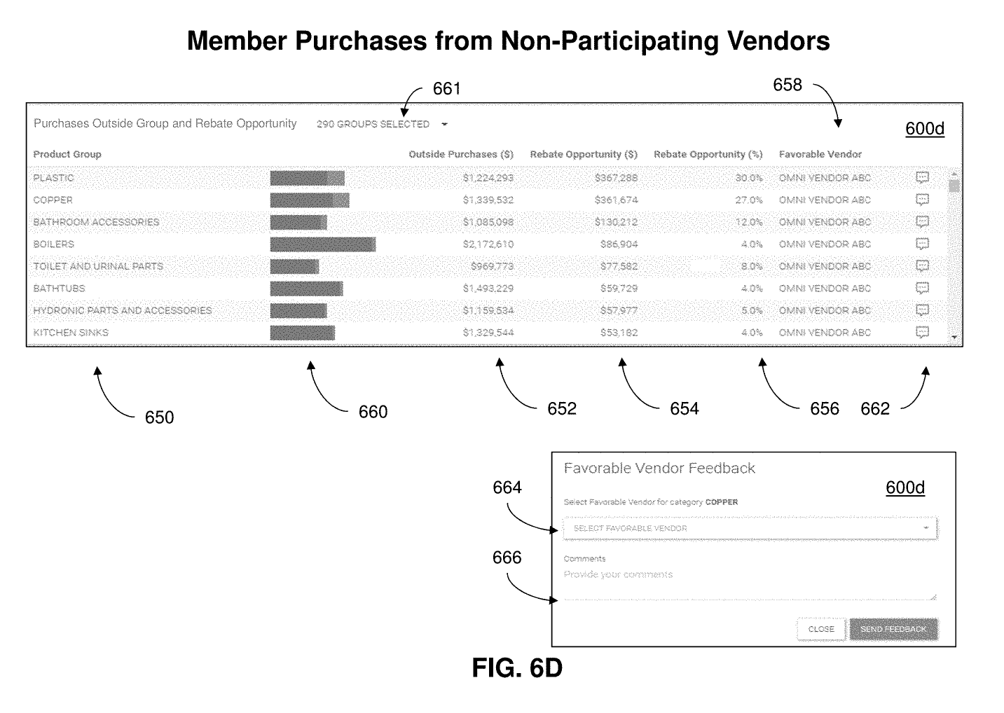

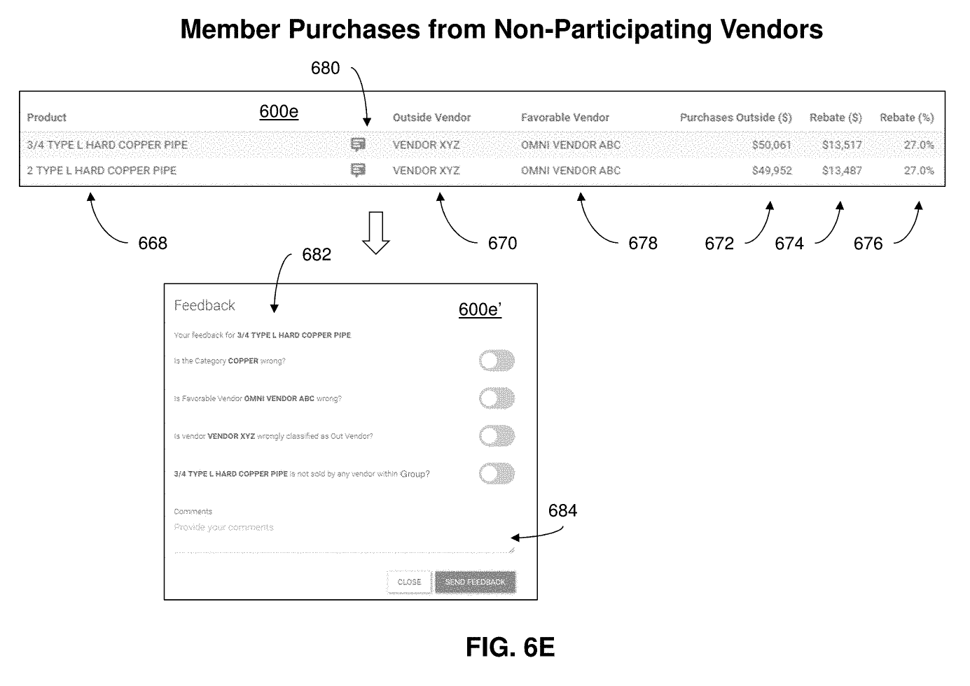

FIGS. 6A-E illustrate example dashboard screens 600a-e customized for a particular member 102 in the buying group 100. For a given time period (e.g., year-to-date), the dashboard screen 600a as shown in FIG. 6A reports a purchase and rebate data summary. In particular, the dashboard screen 600a presents: (i) a total amount 602 of purchases by the particular member 102 from associated vendors 110 of the buying group 100; (ii) a total amount 604 of rebates 13 earned by the particular member 102 and a corresponding indication of YOY percentage increase/decrease; (iii) a total amount 606 of rebates 13 actually received by the particular member 102 and a corresponding indication of YOY percentage increase/decrease; and (iv) a total amount 608 of missed opportunities 17 for rebates for the particular member 102 and a corresponding indication of YOY percentage increase/decrease. As described above, the total amount 608 of rebates 13 indicates the rebates the particular member 102 could have received if the particular member 102 had purchased products 12 from associated vendors 110, instead of purchasing the same or substitute products 22 from non-associated vendors 120. The dashboard screen 600a also provides a bar graph 610 that graphically compares, over time (e.g., monthly) for the given time period, the total amount 604 of rebates 13 earned, the total amount 606 of rebates 13 received, and the total amount 608 of missed opportunities 17 for rebates. The total amount 608 of rebates 13 may be broken down into different types of rebates (e.g., growth rebates), which is presented in a column 612. The dashboard screen 600a also provides a bar graph 614 that graphically presents the rebate information in the column 612 over time for the given time period. The total amount 602 of purchases by the particular member 102 is presented in a row 616 that includes other information on a membership level for the particular member 102. For instance, the particular member 102 may belong to a “Platinum” membership level requiring a certain amount of purchases, so the row 616 may indicate a qualification status for the particular member 102, i.e., whether the total amount 602 of purchases by the particular member 102 meets the requirements for the membership level. The dashboard screen 600a also includes various functions 618 that allow selection of the time period covered by the summary, download of the report to the host (e.g., personal computer), etc.

The dashboard screen 600b as shown in FIG. 6B reports purchase and rebate data for each associated vendor 110 from whom the particular member 102 purchased products 12 for a given time period. The dashboard screen 600b presents: (i) a column 620 listing the associated vendors 110 from whom the particular member 102 purchased products 12; (ii) a column 622 listing respective update dates for each vendor 110 listed in the column 620, where the update dates indicate the latest data from the vendor 110; (iii) a column 624 listing respective purchases from each vendor 110 listed in the column 620; (iv) a column 626 listing respective rebates 13 earned by the particular member 102 from each vendor 110 listed in the column 620; and (v) a column 628 listing respective rebates 13 actually received by the particular member 102 from each vendor 110 listed in the column 620. The dashboard screen 600b also provides a bar graph 630 that graphically indicates the respective purchases from each vendor 110 listed in the column 620. Additionally, the dashboard screen 600b also provides a bar graph 630 that graphically indicates the respective rebates 13 earned from each vendor 110 listed in the column 620. The dashboard screen 600b provides various functions 632 that allow selection of the vendors 110 listed in the column 620, further visualization of the data, viewing of invoices for reconciliation, etc. Furthermore, the dashboard screen 600b provides functions 636 for contacting the vendors 110 in the column 620. For instance, a link to contact information (shown as a “telephone” icon) is provided for each vendor 110. Selection of the link for a given vendor 110 calls up a pop-up window 600b′ with contact information 638 for the vendor 110, as shown in FIG. 6B. Additionally, a download function allows the contact information 638 to be downloaded to the host. In general, a dashboard screen in embodiments may include one or more links to other dashboard screens, for instance to provide more detailed information on one or more particular items presented on the initial dashboard screen.

The dashboard screen 600c as shown in FIG. 6C reports invoice data for the particular member 102 for selected vendors 110, such as those in the dashboard screen 600b shown in FIG. 6B. The invoice data, for instance, may be used for reconciliation. The dashboard screen 600c presents: (i) a column 640 listing selected vendors 110; (ii) columns 642a-d listing respective purchases from each vendor 110 listed in the column 640, including the product 12 (642a), quantity (642b), price per unit (642c), and total price (642d) for the purchase; (iii) columns 644a-b listing respective invoices for each purchase listed in the columns 642a-d, including the invoice number (644a) and the invoice date (644b) (each invoice may include more than one purchase); and (iv) a column 646 listing respective purchase orders associated with each purchase listed in the columns 642a-d (more than one purchase may be associated with each purchase order). The dashboard screen 600c provides various functions 648 that allow selection of the vendors 110 listed in the column 640, selection of period of time for the reported data, search for purchase orders, download of data to the host, etc.

The dashboard screen 600d as shown in FIG. 6D reports purchases by the particular member 102 of products 22 from non-associated vendors 120 and missed opportunities 17 for rebates for such purchases. The dashboard screen 600d presents: (i) a column 650 listing product groups 11 associated with the products 22 purchased from non-associated vendors 120 by the particular member 102; (ii) a column 652 listing the respective purchase totals for each product group 11 listed in the column 650; (iii) a column 654 providing respective missed opportunities 17 for rebates for purchases from non-associated vendors 120 under each product group 11 listed in the column 650; (iv) a column 656 listing respective missed opportunities 17 for rebates as a percentage of the respective purchase totals listed in the column 652; and (v) a column 658 listing respective associated vendors 110 that are favorable sources for products 12 under each product group 11 listed in the column 650. The dashboard screen 600d also provides a bar graph 660 that graphically compares respective purchase totals listed in the column 652 and the respective missed opportunities 17 for rebates 13 listed in the column 654. By listing the favorable associated vendors 110 in the column 658, the dashboard screen 600d identifies a vendor that the particular member 102 can purchase products 12 from within the buying group 100 instead of products 22 from non-associated vendors 120. The dashboard screen 600d also includes a function 661 that allows selection of the product groups 11 listed in the column 650.

The dashboard screen 600d provides a feedback function 662 that allows one to suggest an alternative favorable associated vendor 110 for any of the product groups 11 listed in the column 650. In particular, a link (shown as a “dialog” icon) is provided for each product group 11. Selection of the link for a given product group 11 calls up a pop-up window 600d′ as also shown in FIG. 6D, where one can input an alternative favorable vendor 110 in a field 664 and/or provide comments in a field 666. Such feedback can be evaluated by administrators of the buying group 100 for possible change to the vendor 110 that is considered favorable for the given product group 11.

The dashboard screen 600e as shown in FIG. 6E provides information on products 22 purchased from non-associated vendors 120 by the particular member 102. The dashboard screen 600e presents: (i) a column 668 listing products 22 purchased from non-associated vendors 120; (ii) a column 670 providing the respective non-associated vendors 120 from whom each product 22 listed in the column 668 was purchased; (iii) a column 672 providing respective purchase totals for each product 22 listed in the column 668; (iv) a column 674 providing respective rebate totals for missed opportunities 17 based on purchases of each product 22 listed in the column 668; (v) a column 676 providing respective rebate totals for missed opportunities 17 based on purchases of each product 22 listed in the column 668 as a percentage of the respective purchase totals listed in the column 652; and (vi) a column 678 providing respective associated vendors 110 that are favorable vendors for products 12 that are the same as, or substitutes for, each product 22 listed in the column 668. The particular member 102 provides purchase data 16 as described above. The purchase data 16 is analyzed to identify the products 22 listed in the column 668 and the non-associated vendors 120 provided in the column 670. The product groups 11 to which the products 22 belong are determined and the favorable vendors 110 for the product groups 11 are correspondingly identified.

The dashboard screen 600e also provides a feedback function 680 that allows one to confirm or suggest modifications to the information derived from the purchase data 16 for each product 22 listed in the column 668. In particular, a link (shown as a “dialog” icon) is provided for each product 22, where selection of the link for a given product 22 calls up a pop-up window 600e′ as shown in FIG. 6E. The pop-up window 600e′ provides prompts 682 to confirm the accuracy of the information stored (i.e., in the product database 204) for the given product 22. For instance, by selecting yes or no to the prompts 682, one may confirm that: (i) the given product 22 is associated with the correct product group 11; (ii) the given product 22 is associated with the correct favorable vendor 110; (iii) the correct non-associated vendor 120 is associated with the given product 22; and (iv) the given product 22 is sold by an associated vendor 110. The pop-up window 600e′ also includes a field 684 where one can provide further comments. The feedback provided in the pop-up window 600e′ can be evaluated for possible updates to the information on the given product 22. As described above, dynamic updates based on such feedback build a more accurate product database 204 over time, allowing the platform 200 to identify the missed opportunities 17 more efficiently and more accurately. Additionally, the product information provided by the platform 200 becomes more accurate and the members 102 to evaluate their business activities with better information (e,g., which associated vendor 110 should be used for future purchases).

As described above, the platform 200 can parse information on a product 22 to correlate the product 22 to one or more products 12 from the associated vendors 110. For instance, the platform 200 may identify key word(s) in the name/description of the product 22 that match key word(s) in the names/descriptions of one or more products 12 from the associated vendors 110. Alternatively or additionally, the platform 200 may identify key word(s) in the name/description of the product 22 that indicate that the product 22 belongs to one or more product groups 11, which also include one or more products 12 from the associated vendors 110. For instance, as shown in FIG. 6E, one of the product names listed in the column 668 includes “3/4 TYPE L HARD COPPER PIPE.” The platform 200 may parse the product name and detect the string “COPPER” in the name. In the example of FIG. 6E, one of the product groups 11 in the product database 204 is “COPPER.” As such, the platform 200 may automatically correlate the listed product 22 with this particular product group 11. The pop-up window 600e′ allows users to confirm or correct the correlation made by the platform 200.

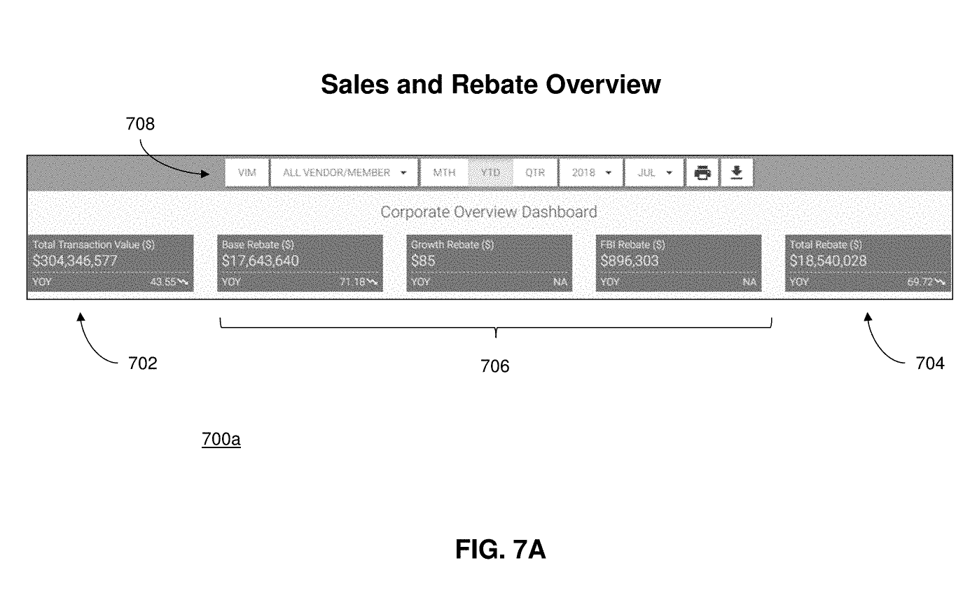

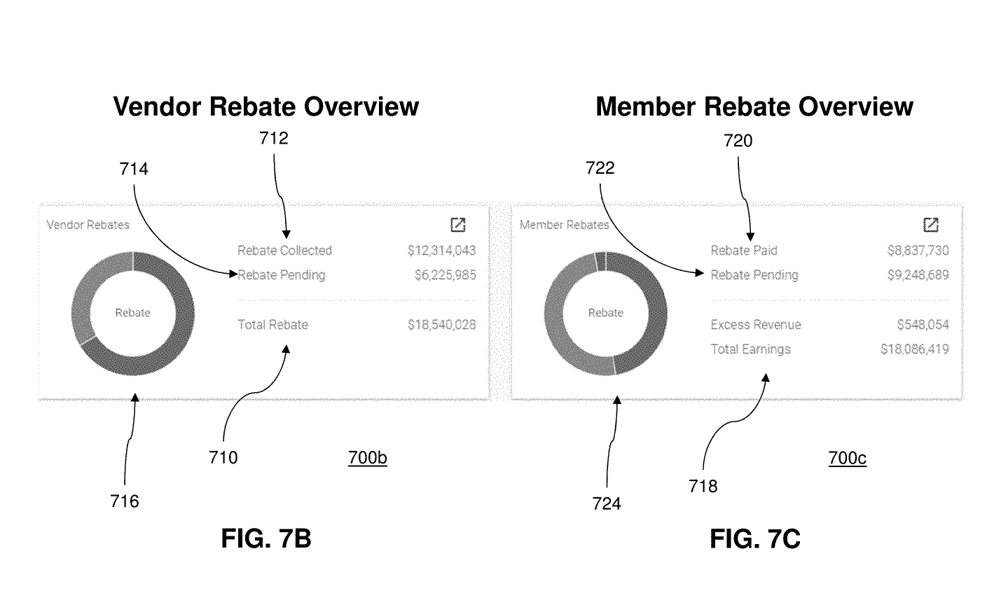

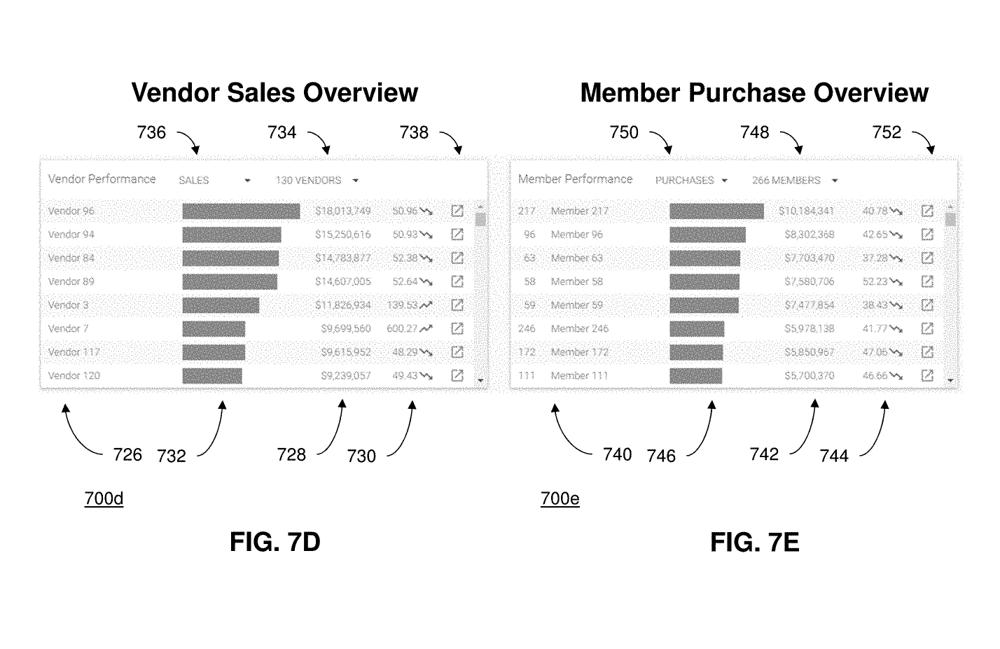

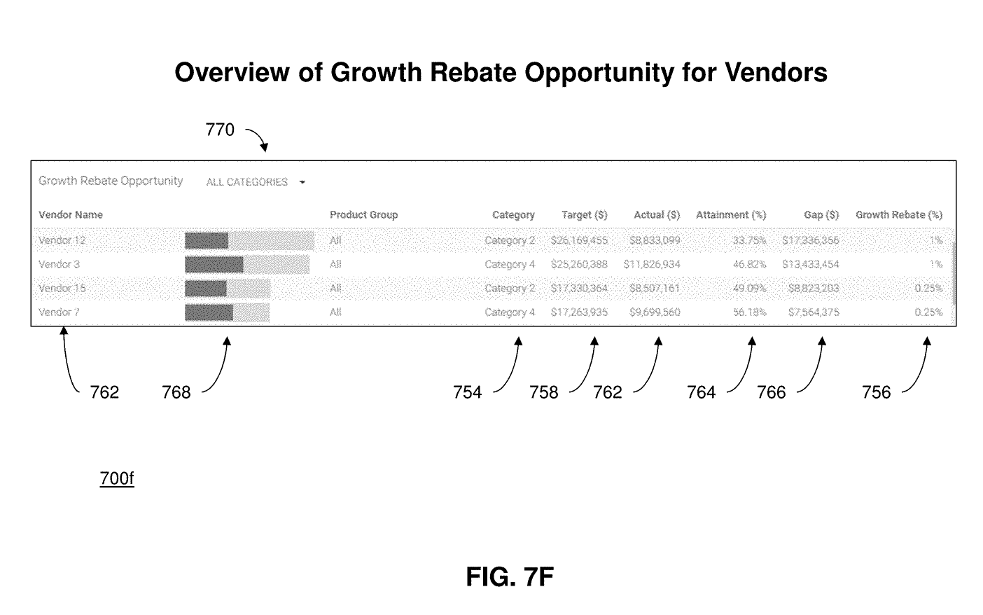

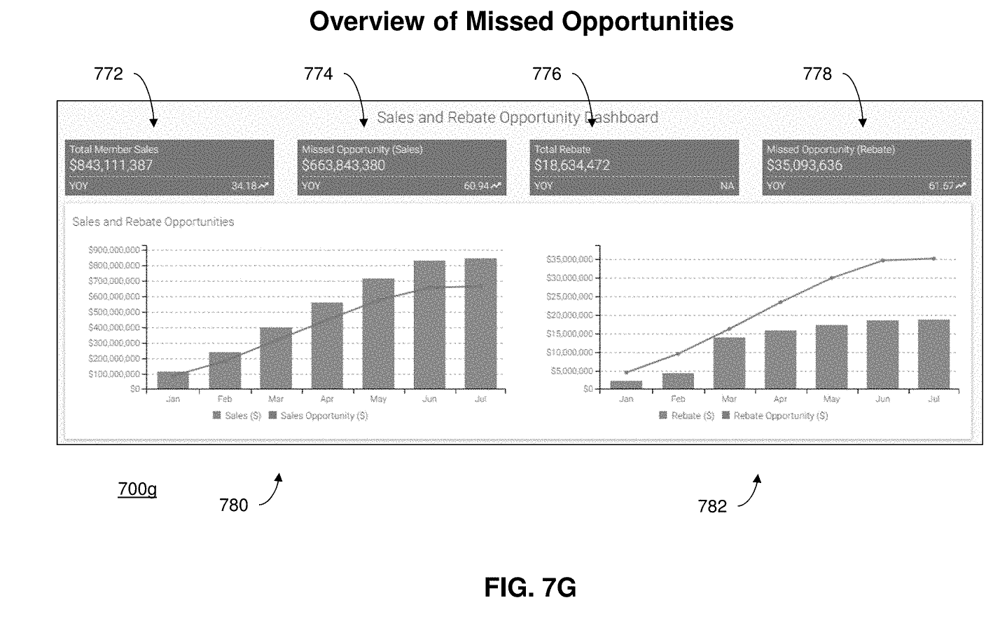

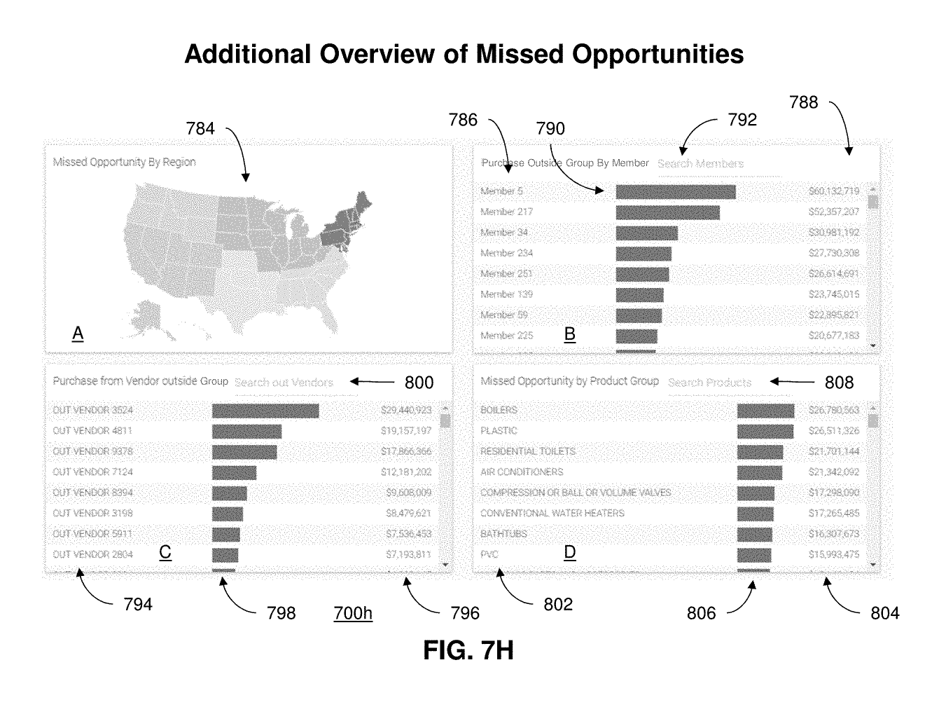

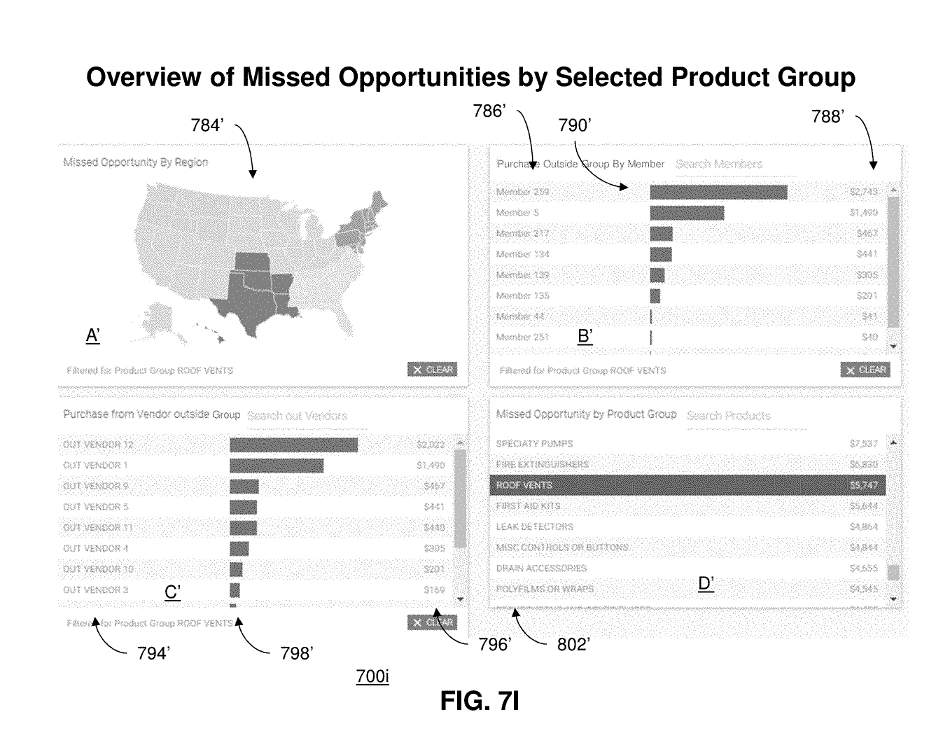

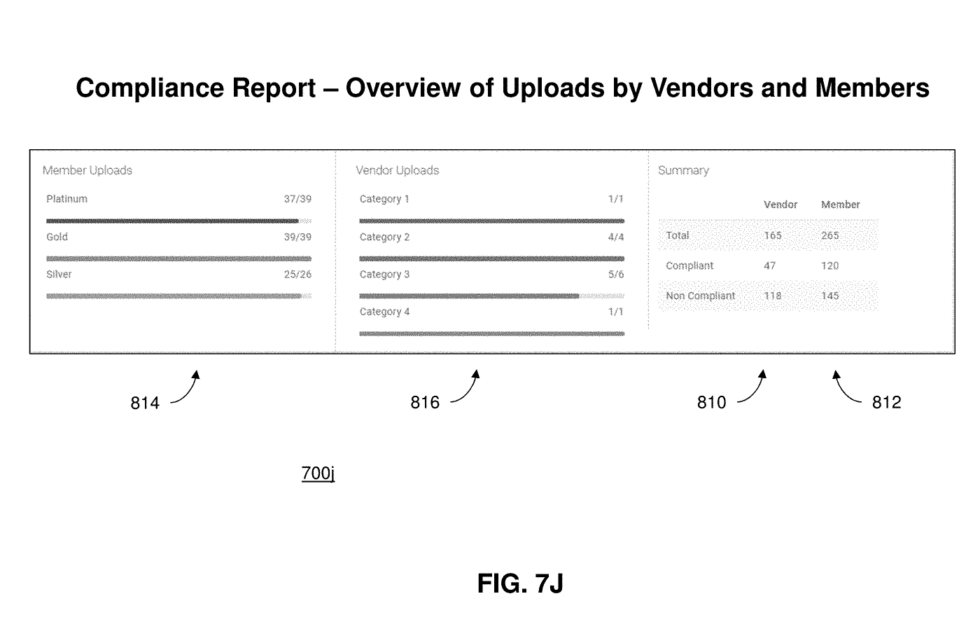

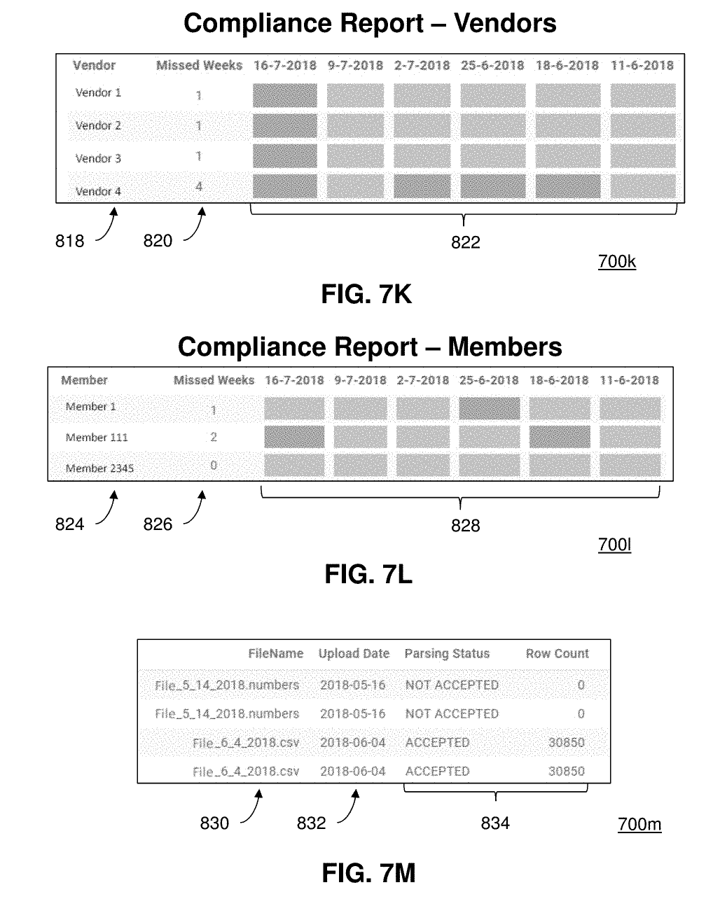

FIGS. 7A-M illustrate example dashboard screens 700a-m customized for administrators of the buying group 100 or other authorized parties who are tasked with reviewing or otherwise managing activities of the buying group 100 as a whole. In general, such dashboard screens provide overviews of activities by any of the members 102 and associated vendors 110 in the buying group. For a given time period (e.g., year-to-date), the dashboard screen 700a as shown in FIG. 7A reports a sales and rebate overview for the buying group 100. In particular, the dashboard screen 700a presents: (i) a total amount 702 of sales between selected members 102 and selected associated vendors 120 and a corresponding indication of YOY percentage increase/decrease, and (ii) a total amount 704 of rebates 13 earned by the selected members 102 and a corresponding indication of YOY percentage increase/decrease. The rebates 13 under the total amount 704 may be broken down into different types of rebates (e.g., growth rebates), which is presented in additional columns 706 with corresponding indications of YOY percentage increase/decrease. The dashboard screen 700a also includes various functions 708 that allow selection of the members 102 and the associated vendors 110 covered by the overview, selection of the time period covered by the overview, printing, download of the report to the host (e.g., personal computer), etc.

The dashboard screen 700b as shown in FIG. 7B provides a rebate overview for the associated vendors 110 for the buying group 100. In particular, the dashboard screen 700b presents: (i) a total amount 710 of rebates 13 earned from all associated vendors 110; (ii) an amount 712 of rebates 13 actually paid by all associated vendors 110; and (iii) a pending amount 714 of rebates 13 still to be paid by all associated vendors 110. The dashboard screen 700b also provides a bar graph 716 that graphically indicates the amount 712 of rebates 13 actually paid by all associated vendors 110 relative to the pending amount 714 of rebates 13 still to be paid by all associated vendors 110.

The dashboard screen 700c as shown in FIG. 7C provides a rebate overview for the members 102 of the buying group 100. In particular, the dashboard screen 700c presents, inter alia: (i) a total amount 718 of rebates 13 earned by all members 102; (ii) an amount 720 of rebates 13 actually paid to all members 102; and (iii) a pending amount 722 of rebates 13 still to be paid to all members 102. The dashboard screen 700c also provides a bar graph 724 that graphically indicates the amount 720 of rebates 13 actually paid to all members 102 relative to the pending amount 722 of rebates 13 still to be paid to all members 102.

The dashboard screen 700d as shown in FIG. 7D provides a sales overview for the associated vendors 110 for the buying group 100. In particular, the dashboard screen 700c presents: (i) a column 726 listing selected associated vendors 110; (ii) a column 728 listing respective sales totals for each associated vendor 110 listed in the column 726; and (iii) a column 730 listing respective YOY increase/decrease for sales totals for each associated vendor 110 listed in the column 726. The dashboard screen 700d also provides a bar graph 732 that graphically indicates the respective sales totals for each associated vendor 110 listed in the column 726. Additionally, the dashboard screen 700d provides a function 734 that allows selection of the associated vendors 110 listed in the column 726. Furthermore, the dashboard screen 700d provides a function 736 that allows selection of the information shown in the dashboard screen 700d. For instance, rather than selecting an overview of sales, one may select an overview of rebates for the selected associated vendors 110 in the dashboard screen 700d. Moreover, the dashboard screen 700d provides respective functions 738 that include links to call up additional information (e.g., in a pop-up window) for each associated vendor 110 listed in the column 726.

The dashboard screen 700e as shown in FIG. 7E provides a purchase overview for the members 102 of the buying group 100. In particular, the dashboard screen 700e presents: (i) a column 740 listing selected members 102; (ii) a column 742 listing respective purchase totals for each member 102 listed in the column 740; and (iii) a column 744 listing respective YOY increase/decrease for purchase totals for each member 102 listed in the column 740. The dashboard screen 700e also provides a bar graph 746 that graphically indicates the respective purchase totals for each member 102 listed in the column 740. Additionally, the dashboard screen 700e provides a function 748 that allows selection of the members 102 listed in the column 726. Furthermore, the dashboard screen 700e provides a function 750 that allows selection of the information shown in the dashboard screen 700e. For instance, rather than selecting an overview of purchases, one may select an overview of rebates for the selected members 102 in the dashboard screen 700e. Moreover, the dashboard screen 700e provides respective functions 752 that include links to call up additional information (e.g., in a pop-up window) for each member 102 listed in the column 740.

The dashboard screen 700f as shown in FIG. 7F provides an overview of progress of attaining growth rebates for selected product groups by the associated vendors 110. In particular, the dashboard screen 700f presents: (i) a column 754 listing product categories for which growth rebates are available; (ii) a column 756 listing respective growth rebates for each product category listed in the column 754; (iii) a column 758 listing respective target sales revenue that must be satisfied to attain each growth rebate listed in the column 756; (iv) a column 760 listing associated vendors 110 selling products 12 in the product categories listed in the column 754; (v) a column 762 listing respective sales revenue 14 received by the associated vendors 110 listed in the column 760 for each product category listed in the column 754, where the respective sales revenue 14 must meet the respective target sales revenue listed in the column 758 to attain the respective growth rebate listed in the column 756; (vi) a column 764 listing the respective sales revenue 14 listed in the column 762 as a percentage of the respective target sales revenue listed in the column 758, indicating the progress toward attaining the respective growth rebate listed in the column 756; and (vi) a column 766 listing respective differences between the respective sales revenue 14 listed in the column 762 and the respective target sales revenue listed in the column 758, indicating the progress toward attaining the respective growth rebate listed in the column 756. The dashboard screen 700f also provides a bar graph 768 that graphically indicates the progress toward attaining the respective growth rebates listed in the column 756. Additionally, the dashboard screen 700f provides a function 770 that allows selection of the product categories listed in the column 754. Other dashboard screens similar to the dashboard screen 700f may be employed to provide information on other types of rebates.

The dashboard screen 700g as shown in FIG. 7G provides an overview of missed opportunities 17 for the members 102 and the associated vendors 110 in the buying group 100. In particular, the dashboard screen 700g presents: (i) a total amount 772 of purchases of products 12 made by the members 102 from the associated vendors 110 and a corresponding indication of YOY percentage increase/decrease; (ii) a total amount 774 of purchases of products 22 made by the members 102 from non-associated vendors 120 and a corresponding indication of YOY percentage increase/decrease; (iii) a total amount 776 of rebates 13 earned by the members 102 from the total amount 774 of purchases and a corresponding indication of YOY percentage increase/decrease; and (iv) a total amount 778 of missed opportunities 17 for rebates 13 based on the purchases of products 22 made by the members 102 from non-associated vendors 120 and a corresponding indication of YOY percentage increase/decrease. The dashboard screen 700g also provides a bar/line graph 780 that graphically indicates the total amount 772 of purchases of products 12 made by the members 102 from the associated vendors 110 relative to total amount 774 of purchases of products 22 made by the members 102 from non-associated vendors 120 over time (e.g., year-to-date). Additionally, the dashboard screen 700g provides a bar/line graph 782 that graphically indicates the total amount 776 of rebates 13 earned by the members 102 relative to the total amount 778 of missed opportunities 17 for rebates 13 over the same time.

The dashboard screen 700h as shown in FIG. 7H provide an additional overview of missed opportunities 17 for the members 102 and the associated vendors 110 in the buying group 100. In particular, the dashboard screen 700h includes a first pane A that presents a map 784 that graphically indicates (e.g., by color) the amount of missed opportunities 17 for the members 102 according to geographical region (e.g., states).

The dashboard screen 700h also includes a second pane B that presents: (i) a column 786 that lists the members 102 in the buying group 100; and (ii) a column 788 that lists respective amounts of purchases of products 22 made by each of the members 102 listed in the column 786 from non-associated vendors 120. The respective amounts of purchases of products 22 listed in the column 788 represent missed opportunities 17 for rebates 13 for the members 102 as well as for sales revenue 14 for associated vendors 110. The pane B also provides a bar graph 790 that graphically indicates the respective amounts of purchases of products 22 made by each of the members 102 listed in the column 786 from non-associated vendors 120. Additionally, the pane B provides a function 792 that allows one to search for information on a particular member 102.

The dashboard screen 700h includes a third pane C that presents: (i) a column 794 that lists non-associated vendors 120 from whom the members 102 have purchased products 22; and (ii) a column 796 that lists respective amounts of purchases of products 22 made from each of the non-associated vendors 120 listed in the column 794. The respective amounts of purchases of products 22 listed in the column 796 represent missed opportunities 17 for rebates 13 for the members 102 as well as for sales revenue 14 for associated vendors 110. The pane C also provides a bar graph 798 that graphically indicates the respective amounts of purchases of products 22 made from each of the non-associated vendors 120 listed in the column 794. Additionally, the pane C provides a function 800 that allows one to search for information for a particular non-associated vendor 120.

The dashboard screen 700h includes a fourth pane D that presents: (i) a column 802 that lists the product groups 11 under which products 22 were purchased from non-associated vendors 120; and (ii) a column 804 that lists respective amounts of purchases of products 22 made from the non-associated vendors 120 under each product group 11 listed in the column 802. The respective amounts of purchases of products 22 listed in the column 804 represent missed opportunities 17 for rebates 13 for the members 102 as well as for sales revenue 14 for associated vendors 110. The pane D also provides a bar graph 806 that graphically indicates the respective amounts of purchases of products 22 made from the non-associated vendors 120 under each product group 11 listed in the column 802. Additionally, the pane D provides a function 808 that allows one to search for information for a particular product group 11.

The pane D also allows one to select one of the product groups 11 from the column 802 to obtain another overview of missed opportunities 17 associated with the selected product group 11. In particular, each of the product groups 11 as listed in the column 802 may provide a link to another overview. For instance, selection of the “ROOF VENTS” product group in the column 802 can modify the dashboard screen 700h to appear as the dashboard screen 700i shown in FIG. 7I. Upon selection of a product group 11 (e.g., the “ROOF VENTS” product group), a pane D′ in the dashboard screen 700i, which is similar to the pane D in the dashboard screen 700h, highlights the selected product group 11 in a column 802′, which lists the product groups 11 under which products 22 were purchased from non-associated vendors 120. Panes A′, B′, and C′ in the dashboard screen 700i may be similar to the panes A, B, and C in the dashboard screen 700h, respectively, but the information in the panes A′, B′, and C′ relates to the selected product group 11.

Accordingly, the pane A′ of the dashboard screen 700i presents a map 784′ that graphically indicates the amount of missed opportunities 17 for the members 102 for the selected product group 11 according to geographical region.

The pane B′ of the dashboard screen 700i presents: (i) a column 786′ that lists the members 102 who have made purchases of products 22 in the selected product group 11 from non-associated vendors 120; and (ii) and a column 788′ that lists respective amounts of purchases of products 22 in the selected product group 11 made by each of the members 102 listed in the column 786′ from non-associated vendors 120. The pane B′ also provides a bar graph 790′ that graphically indicates the respective amounts of purchases of products 22 in the selected product group 11 made by each of the members 102 listed in the column 786′ from non-associated vendors 120.

The pane C′ of the dashboard screen 700i presents: (i) a column 794′ that lists non-associated vendors 120 from whom the members 102 have purchased products 22 in the selected product group 11; and (ii) a column 796′ that lists respective amounts of purchases of products 22 in the selected product group 11 made from each of the non-associated vendors 120 listed in the column 794′. The pane C′ also provides a bar graph 798′ that graphically indicates the respective amounts of purchases of products 22 in the selected product group 11 made from each of the non-associated vendors 120 listed in the column 794′.

As described above, the platform 200 processes the sales data 15 from associated vendors 110 and the purchase data 16 from members 102 to identify the missed opportunities 17. Accurate identification of the missed opportunities 17 depends on compliance by the associated vendors 110 and the members 102 in providing current and accurate sales data 15 and purchase data 16, respectively. Accordingly, the dashboard screens 700j-m shown in FIGS. 7J-M report on such compliance by the associated vendors 110 and the members 102.

The dashboard screen 700j as shown in FIG. 7J presents: (i) a summary 810 of vendor compliance, including a total number of associated vendors 110 in the buying group 100, a number of the associated vendors 110 who have complied with requirements to upload sales data 15 (e.g., by a deadline), and a number of the associated vendors 110 who have not complied with requirements to upload the sales data 15; and (ii) a summary 812 of member compliance, including a total number of members 102 in the buying group 100, a number of the members 102 who have complied with requirements to upload purchase data 16, and a number of the members 102 who have not complied with requirements to upload the purchase data 16. As described above, the members 102 may belong to different membership levels for the buying group 100. As such, the dashboard screen 700j also presents a bar graph 814 that graphically organizes the members 102 into the different membership levels and indicates the amount of compliance for each membership level. The associated vendors 110 may be organized into different categories for the buying group 100. As such, the dashboard screen 700j also presents a bar graph 816 that graphically organizes the associated vendors 110 into the different categories and indicates the amount of compliance for each vendor category.

The dashboard screen 700k shown in FIG. 7K reports on compliance by each associated vendor 110. In particular, the dashboard screen 700k presents a matrix that includes a column 818 listing the associated vendors 110 and a column 820 that summarizes a total number of missing uploads of sales data 15 for each respective associated vendor 110. The matrix includes a series of columns 822 representing respective time periods (e.g., weeks) for which the associated vendors 110 are required to upload the sales data 15. If an associated vendor 110 has complied by uploading the sales data 15 for a given time period, a respective cell in the column 822 for the given time period is marked (e.g., with green shading) to indicate compliance. On the other hand, if a associated vendor 110 has failed to upload the sales data 15 for a given time period, a respective cell in the column 822 for the given time period is marked (e.g., with red shading) to indicate non-compliance.

The dashboard screen 700l shown in FIG. 7L reports on compliance by each member 102. In particular, the dashboard screen 700l presents a matrix that includes a column 824 listing the members 102 and a column 826 that summarizes a total number of missing uploads of purchase data 16 for each respective member 102. The matrix includes a series of columns 828 representing respective time periods (e.g., weeks) for which the members 102 are required to upload the purchase data 16. If a member 102 has complied by uploading the purchase data 16 for a given time period, a respective cell in the column 828 for the given time period is marked (e.g., with green shading) to indicate compliance. On the other hand, if a member 102 has failed to upload the purchase data 16 for a given time period, a respective cell in the column 828 for the given time period is marked (e.g., with red shading) to indicate non-compliance.

In the dashboard screens 700k, 1, the cells of the matrices can be selected to call up a pop-up window with file upload information for the corresponding associated vendor 110 or the member 102. For instance, the pop-up window 700m shown in FIG. 7M may appear by selecting certain cells. The pop-up window 700m presents: (i) a column 830 listing files that a associated vendor 110 or member 102 attempted to upload; (ii) a column 832 listing respective dates for the upload attempts for each file listed in the column 830; and (iii) columns 834 providing information on the processing of the upload attempts for each file listed in the column 830.

Typical challenges in managing a buying group include: sales data from vendors that is not standardized; sales data from vendors that is not timely; sales data from vendors that is not sufficiently granular; an inability to reconcile sales data from vendors due to the unavailability of purchase data from buying group members; low/poor rebate compliance; an inability to determine missed opportunities; manual, tedious, and potentially inaccurate rebate calculation; and an inability to gain insight into purchasing behavior by buying group members. In contrast, advantages of a buying group platform according to aspects of the present disclosure include: standardized data; timely data; higher compliance; ability to reconcile sales data from vendors with purchase data from buying group members; an end-to-end automated, computer-based process; ability to calculate missed opportunities; ability to determine/understand product preferences of buying group members; and ability to track of progress of growth incentives.

According to some aspects of the present disclosure, some or all of the steps of the above-described and illustrated procedures can be automated or guided under the control of a computer-based technical architecture, such as the technical architecture 300 shown in FIG. 4. The embodiments described herein may employ various computing systems, such as the analytics engine 306, for processing information and controlling aspects transmitting, receiving, and presenting content. The processor(s) of a computing system may be implemented as a combination of hardware and software elements. The hardware elements may include combinations of operatively coupled hardware components, including microprocessors, communication/networking interfaces, memory, signal filters, circuitry, etc. The processors may be configured to perform operations specified by the software elements, e.g., computer-executable code stored on computer readable medium. The processors may be implemented in any device, system, or subsystem to provide functionality and operation according to the present disclosure. The processors may be implemented in any number of physical devices/machines. Indeed, parts of the processing of the example embodiments can be distributed over any combination of processors for better performance, reliability, cost, etc.

The physical devices/machines can be implemented by the preparation of integrated circuits or by interconnecting an appropriate network of conventional component circuits, as is appreciated by those skilled in the electrical art(s). The physical devices/machines, for example, may include field programmable gate arrays (FPGA's), application-specific integrated circuits (ASIC's), digital signal processors (DSP's), etc. The physical devices/machines may reside on a wired or wireless network, e.g., LAN, WAN, Internet, cloud, near-field communications, etc., to communicate with each other and/or other systems, e.g., Internet/web resources.

Appropriate software can be readily prepared by programmers of ordinary skill based on the teachings of the example embodiments, as is appreciated by those skilled in the software arts. Thus, the example embodiments are not limited to any specific combination of hardware circuitry and/or software. Stored on one computer readable medium or a combination of computer readable media, the computing systems may include software for controlling the devices and subsystems of the example embodiments, for driving the devices and subsystems of the example embodiments, for enabling the devices and subsystems of the example embodiments to interact with a human user (user interfaces, displays, controls), etc. Such software can include, but is not limited to, device drivers, operating systems, development tools, applications software, etc. A computer readable medium further can include the computer program product(s) that provide programmed instructions for performing all or a portion of the processing for the example embodiments. Computer program products employed for the example embodiments can include any suitable interpretable or executable code mechanism, including but not limited to complete executable programs, interpretable programs, scripts, dynamic link libraries (DLLs), applets, etc. The processors may include, or be otherwise combined with, computer-readable media.

Some forms of computer-readable media may include, for example, a hard disk, any other suitable magnetic medium, CD-ROM, CDRW, DVD, any other suitable optical medium, RAM, PROM, EPROM, FLASH-EPROM, any other suitable memory chip or cartridge, or any other suitable data storage hardware from which a computer can read. The computer-readable media may be employed to store data, which may be organized into databases with database management software or the like. Such databases may include, for instance, the product database 204, the member database 308, and the vendor database 310 described above.

In the foregoing detailed description, reference is made to the accompanying figures, which form a part hereof. It should be understood that arrangements described herein are for purposes of example only. As such, those skilled in the art will appreciate that other arrangements and other elements (e.g., machines, interfaces, functions, orders, groupings of functions, etc.) can be used instead or in addition, and some elements may be omitted altogether according to the desired results. Further, many of the elements that are described are functional entities that may be implemented as discrete or distributed components or in conjunction with other components, in any suitable combination and location. Various functions described herein as being performed by one or more entities may be carried out by hardware, firmware or software logic. For instance, various functions described herein may be carried out by a processor executing instructions written in any suitable programming language and stored in memory.

While the present disclosure has been described with reference to one or more particular embodiments, those skilled in the art will recognize that many changes may be made thereto without departing from the spirit and scope of the present disclosure. Each of these embodiments and obvious variations thereof is contemplated as falling within the spirit and scope of the disclosure. It is also contemplated that additional embodiments according to aspects of the present disclosure may combine any number of features from any of the embodiments described herein.

What is claimed is:

1. A platform for managing activities of a buying group, comprising:
one or more data interfaces configured to receive purchase data from one of a plurality of members of a buying group, the purchase data including information on a purchase, by the one member, of a product sold by a non-associated vendor, the non-associated vendor not being associated with the buying group;
a product database stored on one or more computer-readable media and configured to store product information relating to a substitute product sold by an associated vendor, the associated vendor being associated with the buying group;
a vendor database stored on the one or more computer-readable media and configured to store vendor information relating to the associated vendor, the vendor information indicating that the associated vendor provides one or more benefits for a purchase of the substitute product by any member of the buying group; and
a computing system including one or more processors executing programmed instructions stored on the one or more computer-readable media, the computing system configured to:
identify, from the purchase data, the purchase of the product from the non-associated vendor by the one member;
identify, from the product database, the substitute product sold by the associated vendor by determining a correlation between the product sold by the non-associated vendor and the substitute product;
determine, from the vendor database, the one or more benefits for the purchase of the substitute product;
generate one or more dashboard screens providing information relating to the purchase of the product from the non-associated vendor by the one member; and
transmit, over a network, the one or more dashboard screens for presentation to at least one of the one member or the associated vendor.

2. The platform according to claim 1, wherein one of the dashboard screens includes a member dashboard screen that indicates a missed purchase opportunity to purchase the substitute product from the associated vendor and to receive the corresponding one or more benefits from the associated vendor, and the computing system transmits the member dashboard screen to the one member.

3. The platform according to claim 1, wherein one of the dashboard screens includes a vendor dashboard screen that indicates a missed sales opportunity to sell the substitute product to the one member, and the computing system transmits the vendor dashboard screen to the associated vendor.

4. The platform according to claim 1, wherein the one or more data interfaces are further configured to receive sales data from the associated vendor, one of the dashboard screens includes a vendor dashboard screen that reports sales by the associated vendor, and the computing system transmits the vendor dashboard screen to the associated vendor.

5. The platform according to claim 4, wherein the computing system is further configured to generate an administrator dashboard screen that provides compliance information regarding receipt of the purchase data from the one member and the sales data from the associated vendor via the one or more interfaces, and the computing system transmits the administrator dashboard screen over the network to one or more administrators of the buying group.

6. The platform according to claim 1, wherein the product information stored in the product database indicates the correlation between the product sold by the non-associated vendor and the substitute product sold by the associated vendor.

7. The platform according to claim 6, wherein the one or more dashboard screens are configured to receive feedback from at least one of the one member or the associated vendor regarding the correlation determined between the product sold by the non-associated vendor and the substitute product sold by the associated vendor, and the computer system is further configured to receive the feedback over the network and to update the product information according to the feedback.

8. The platform according to claim 1, wherein the product information stored in the product database is organized according to one or more product groups, and the product sold by the non-associated vendor and the substitute product sold by the associated vendor are correlated by belonging to a same product group.

9. The platform according to claim 1, wherein the computer system is further configured to update the product information in the product database to include the correlation determined between the product sold by the non-associated vendor and the substitute product sold by the associated vendor.

10. The platform according to claim 1, wherein, to determine the correlation, the computer system parses the information relating to the product sold by the non-associated vendor to find a match with the product information relating to the substitute product.

11. The platform according to claim 1, wherein the one or more benefits includes at least one of a rebate or a commission.

12. A method for managing activities of a buying group, comprising:
receiving, via one or more data interfaces, purchase data from one of a plurality of members of a buying group, the purchase data including information on a purchase, by the one member, of a product sold by a non-associated vendor, the non-associated vendor not being associated with the buying group;
storing, on one or more computer-readable media, a product database including product information relating to a substitute product sold by an associated vendor, the associated vendor being associated with the buying group;
storing, on the one or more computer-readable media, a vendor database including vendor information relating to the associated vendor, the vendor information indicating that the associated vendor provides one or more benefits for a purchase of the substitute product by any member of the buying group;
identifying, from the purchase data, with a computing system including one or more processors, the purchase of the product from the non-associated vendor by the one member;
identifying, from the product database, with the computing system, the substitute product sold by the associated vendor by determining a correlation between the product sold by the non-associated vendor and the substitute product sold by the associated vendor;
determining, from the vendor database, with the computing system, the one or more benefits for the purchase of the substitute product;
generating one or more dashboard screens providing information relating to the purchase of the product from the non-associated vendor by the one member; and
transmitting, over a network, with the computing system, the one or more dashboard screens for presentation to at least one of the one member or the associated vendor.

13. The method according to claim 12, wherein one of the dashboard screens includes a member dashboard screen that indicates a missed purchase opportunity to purchase the substitute product from the associated vendor and receive the corresponding one or more benefits from the associated vendor, and the member dashboard screen is transmitted to the one member.

14. The method according to claim 12, wherein one of the dashboard screens includes a vendor dashboard screen that indicates a missed sales opportunity to sell the substitute product to the one member, and the vendor dashboard screen is transmitted to the associated vendor.

15. The method according to claim 12, further comprising receiving sales data from the associated vendor, wherein one of the dashboard screens includes a vendor dashboard screen that reports sales by the associated vendor, and the vendor dashboard screen is transmitted to the associated vendor.

16. The method according to claim 15, further comprising generating an administrator dashboard screen that provides compliance information regarding the receiving of the purchase data from the one member and the sales data from the associated vendor via the one or more interfaces, and the administrator dashboard screen is transmitted over the network to one or more administrators of the buying group.

17. The method according to claim 12, wherein the product information stored in the product database indicates the correlation between the product sold by the non-associated vendor and the substitute product sold by the associated vendor.

18. The method according to claim 17, further comprising:
receiving feedback, via the one or more dashboard screens and over the network, from at least one of the one member or the associated vendor regarding the correlation between the product sold by the non-associated vendor and the substitute product sold by the associated vendor; and
updating the product database according to the feedback.

19. The method according to claim 12, wherein the product information stored in the product database is organized according to one or more product groups, and the product sold by the non-associated vendor and the substitute product sold by the associated vendor are correlated by belonging to a same product group.

20. The method according to claim 12, further comprising updating the product information in the product database to include the correlation determined between the product sold by the non-associated vendor and the substitute product sold by the associated vendor.
